(19) United States
(12) Patent Application Publication
(10) Pub. No.: US 2002/0077712 A1
(43) Pub. Date: Jun. 20, 2002

(54) System and method for providing return on investment data for wagers

(76) Inventors: Aman Safaei, South Pleasantville, NY (US); Wen Rong Wu, Bayside, NY (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 09/911,932

(22) Filed: Jul. 24, 2001

Related U.S. Application Data
(63) Continuation-in-part of application No. 09/703,171, filed on Oct. 31, 2000.

(51) Int. Cl. G06F 155/00

(52) U.S. Cl. 700/93

(57) ABSTRACT

A user is prompted to select at least one search parameter for a search of contest data for a plurality of contest events and user wager data, the user wager data identifying a plurality of wagers placed by the user on contest events from the plurality of contest events. At least one search parameter selected by the user is received, and wagers placed by the user that satisfy the at least one search parameter selected by the user are identified. A return on the wagers placed by the user that satisfy the at least one search parameter selected by the user is calculated, and wagering return data corresponding to the return are displayed to the user.

### CROSS-REFERENCE TO RELATED APPLICATIONS

This application is a continuation in part of application Ser. No. 09/703,171 to Aman Safaei and Wen Rong Wu, entitled “Interactive Internet Wagering System,” filed Oct. 31, 2000, the entirety of which is hereby incorporated by reference herein.

### FIELD OF THE INVENTION

The present invention relates to wagering systems, and more particularly to a wagering system utilizing the Internet and systems providing wagering data via the Internet.

### BACKGROUND OF THE INVENTION

Wagering systems, such as systems for wagering on horse races, have been developed which allow a user of an off-track user terminal to place a wager on a racing event without having to travel to a track or park. Examples of such systems are described in U.S. Pat. Nos. 5,830,068 and 6,004,211 to Brenner et al.

Brenner et al. describes a wagering system where video signals and data related to horse races are transmitted to a user terminal designed to receive the video signals and data and display the racing data for viewing by a user. The racing data and video signals are transmitted through a television system and are received by a user terminal that includes a television receiver. The user terminal then displays the racing data and video signals on a television monitor connected to the user terminal. Wagers may also be placed using the user terminal.

Wagering systems such as Brenner et al. suffer from several limitations. First, the user terminal must be designed to receive a television transmission and process the received racing data. The user terminal, then, is limited to functioning in conjunction with mass television transmission systems such as cable, broadcast or satellite systems. The practicality, growth potential, accessibility, and flexibility of such system is, therefore, severely limited by the terminal's dependence on a participating transmission system and the transmission system's transmission method (e.g., satellite, cable, or broadcast). The geographic availability of a system is also bounded by the coverage area and customer base of an individual television system participating in the transmission of racing data. A user terminal cannot access racing data if it is outside of the coverage area of one of these television systems or if it is moved within the coverage area of a system utilizing a transmission method for which it was not designed.

Telephone wagering systems also exist in some states, such as Connecticut. A wagerer obtains wagering data, such as the races scheduled at U.S. tracks and entries in each race, typically from a paper program. The wagerer then uses a hard copy table, such as a table printed on a card, to identify the proper telephone wagering code, e.g., an interactive voice response code, that may be used to place a wager from a telephone, typically a touch tone telephone.

These telephone wagering systems require the user to generate his or her own codes from complex tables of potential tracks, races, wagers, and wager amounts. Also, different systems use different codes. Further, the user must cost his or her own wagers by hand in order to know the exact amount of his or her wagers, no small task with complex wagers such as boxes, keys, and partial wins.

Further, wagering laws are currently adapting to accommodate wagering over networks such as the Internet. Therefore, there remains a need for a more flexible wagering system which does not require an interested wagerer to use a dedicated wagering terminal and which permits the user to place a wager from almost anywhere in the world. There also remains a need for a more comprehensive and customizable way to provide a user with wagering data and provide a user with an opportunity to place a wager based upon the received wagering data. Still further, there remains a need to simplify the generation of wagering codes for telephone wagering systems, as well as automate the costing of the wagers represented by these codes.

### SUMMARY OF THE INVENTION

The present invention is a system and method of providing wagering return data to a user through a computer network. A user is prompted through said computer network to select using a user terminal at least one search parameter for a search of contest data for a plurality of contest events and user wager data, the user wager data identifying a plurality of wagers, the plurality of wagers being placed by the user on contest events from the plurality of contest events, in order to identify wagers placed by the user that satisfy the at least one search parameter. At least one search parameter selected by the user is received, and wagers placed by the user that satisfy the at least one search parameter selected by the user are identified. A return on the wagers placed by the user that satisfy the at least one search parameter selected by the user is calculated, and wagering return data corresponding to the return are displayed to the user with the user terminal.

The system and method allow the user to analyze his or her wagering history, such as his or her wagering history on racing events, such as by restricting and organizing wagers that the user has placed according to where or how the wagers were placed, the type of wager placed, or the specific race conditions or race characteristics that may be associated with a race upon which the user has placed a wager. The user receives wagering return data that allow the user to quantitatively and qualitatively evaluate his or her wagering prowess, as well as evaluate specific wagering strategies. Stored data may be associated with specific wagers and enhance the ability of the user to define wagering trends and examine wagering results. Since the racing data is already stored, the user may also evaluate wagers placed at off-track locations or placed in person at the track without providing this information. The user need only register the wager type, selections and wager amounts on a specific race, and racing data, such as the number of entries in the race, track conditions, purse value, etc . . . , as well as results and payouts for the race are available to the system. The user can search for the registered wager using search parameters specifying the available racing data and user wager data.

The system may be used in connection with a plurality of different kinds of racing events, and even other sporting events. Examples of contests include horse racing contests, dog racing contests, automobile racing contests, basketball contests, football contests, soccer contests, hockey contests, baseball contests, golf contests, tennis contests, jaialai contests, or even game show contests. In essence, individual wagers may be associated with the details of the individual contents. This allows for a comprehensive and intricate means of searching and cross-referencing user wager data with contest event data.

The above and other features of the present invention will be better understood from the following detailed description of the preferred embodiments of the invention that is provided in connection with the accompanying drawings.

### BRIEF DESCRIPTION OF THE DRAWINGS

The accompanying drawings illustrate preferred embodiments of the invention, as well as other information pertinent to the disclosure, in which:

FIG. 1 is block diagram of an exemplary combined Internet and telephone wagering system according to the present invention;

FIG. 2 is a block diagram illustrating an exemplary initial contest selection process;

FIG. 3 is a block diagram illustrating options presented to a user accessing an exemplary horse racing contest page according to the present invention;

FIG. 4 is a block diagram illustrating options presented by an exemplary news module according to the present invention;

FIG. 5 is a block diagram illustrating options presented by an exemplary products module according to the present invention;

FIG. 5A is an illustration of an exemplary product board according to the present invention;

FIG. 6 is a block diagram illustrating options presented by an exemplary track board module according to the present invention;

FIG. 7 is an illustration of an exemplary track board according to the present invention;

FIGS. 8A-8D illustrate exemplary displays of entry data, program data, odds data and results data according to the present invention;

FIG. 9 is a block diagram illustrating options presented by an exemplary race board module according to the present invention;

FIGS. 9A-9E illustrate exemplary displays from a race board according to the present invention;

FIG. 10 is a block diagram illustrating options presented by an exemplary search board module according to the present invention;

FIGS. 10A-10C illustrate exemplary displays from a search board according to the present invention;

FIG. 11 is a block diagram illustrating options presented by an exemplary code module according to the present invention;

FIGS. 11A-11D illustrate exemplary displays from an Interactive Voice Response code board according to the present invention;

FIG. 12 is a block diagram illustrating options presented by an exemplary contest module according to the present invention;

FIGS. 12A and 12B illustrate exemplary displays from a contest board according to the present invention;

FIG. 13 is a functional block diagram of an exemplary video module according to the present invention;

FIG. 14 is a block diagram illustrating options presented by an exemplary return on investment module according to the present invention; and

FIGS. 15-15C illustrate the displays of an exemplary return on investment board according the present invention.

### DETAILED DESCRIPTION OF THE PREFERRED EMBODIMENTS

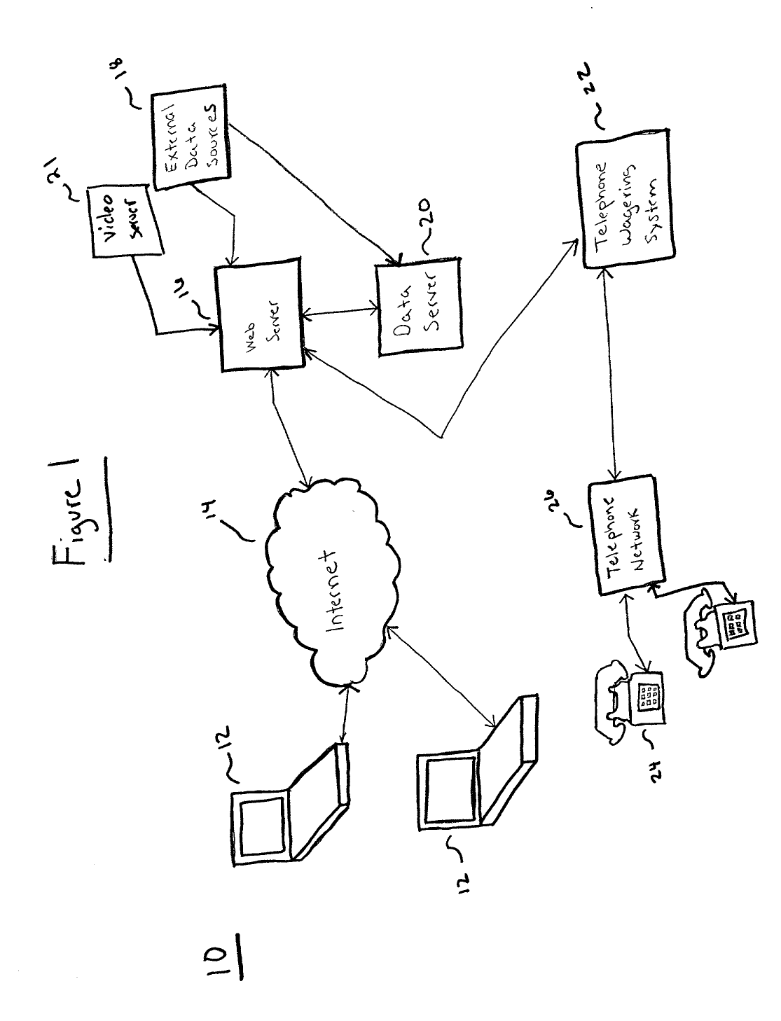

FIG. 1 is a block diagram of an exemplary combined Internet and telephone wagering system 10. User terminals, such as computers 12, are connected to a computer network, such as Internet 14. Computers 12 may connect to Internet 14 through a telephone line and local Internet service provider, through a dedicated line, as is common in many businesses, a local area network, broadband connection, or the like. Computer 12 can also connect to the Internet using wireless technology, such as hand held units connecting to the Internet via the wireless access protocol (WAP). A computer 12 generally accesses a web server 16 using the domain name of the web server 16 and Internet browser software, such as NETSCAPE or Microsoft's INTERNET EXPLORER. The user terminal may also be a pager which can communicate through the Internet using the Internet Protocol, a Kiosk with Internet access, a connected electronic planner (e.g., a PALM device manufactured by Palm, Inc.) or other thin device capable of interactive Internet communication, such as an electronic personal planner, or combination thereof.

The details of the services provided by the web server 16 of the present invention are described below, but other elements of exemplary system 10 are first described. The web server 16 is preferably connected to external data sources 18. External data sources 18 provide wagering related data to web server 16 for processing or transmitting through Internet 14 to a computer 12. A data server 20 may also be connected to web server 16 and external data sources 18. Data server 20 serves as additional storage for data received from external data sources or other wagering-related data. When required, web server 16 can access data server 20 to retrieve this information, and external data sources 18 can download data directly to data server 20.

An external data source may be any source of wagering related data, such as a source of news articles, a totalizator, a source of live odds, a handicapping source, a tips selection source, statistical data source, a weather source, an injury report source, etc. The external data source may be connected to the web server 16 or data server 20 by a dedicated line or the external data source may be hand entry of data or download from a floppy diskette, CD-ROM, or other data storage device.

Web sever 16 may also be connected to a telephone wagering system 22. The telephone wagering system 22 may include an Interactive Voice Response (IVR) system, which translates analog tones transmitted from touch tone telephones into usable information. IVR systems are known and widely used in automated telephone systems. The telephone wagering system 22 is also connected to telephones 24 through a telephone network 26. Alternatively, telephone communications can be transmitted over Internet 14 using voice over IP protocol, avoiding the need potentially to make any long distance telephone calls.

The system 10, as is described below, may be used to provide detailed wagering information for contests to users, as well as allow a user of a user terminal 12 to place wagers on a selected contest. The system, although described in conjunction with horse racing contests below, may be implemented to provide the above-mentioned and below-described features for any contest on which a user may place a wager, such as a dog race, a harness race, an automobile race, bicycle race, a basketball game, a football game, a soccer game, a hockey game, a baseball game, a golf tournament, a tennis match, a jaialai contest, a game show contest and the like.

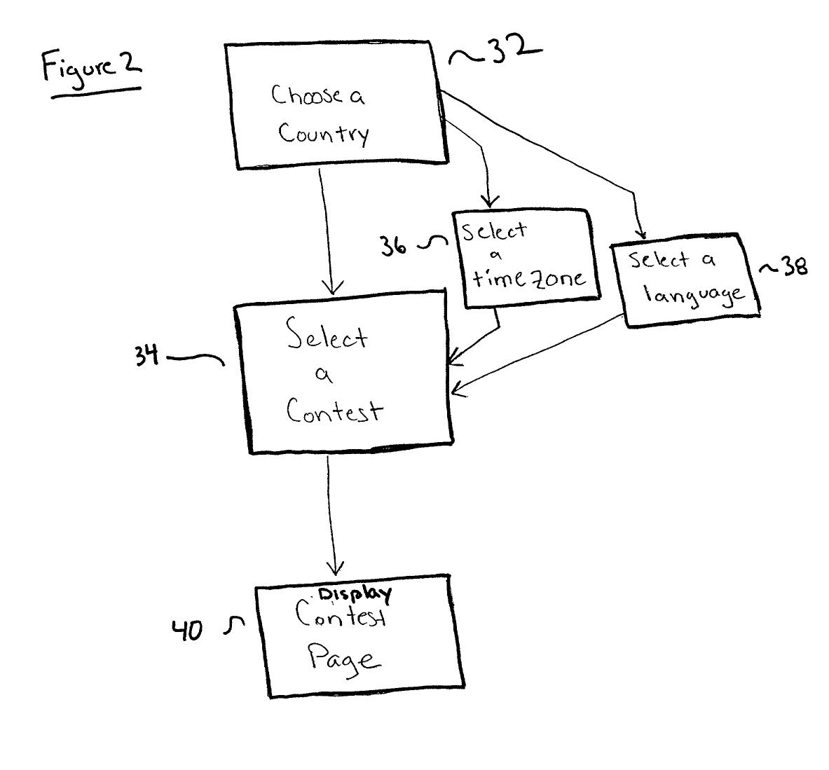

An Internet based system, such as wagering system 10, is global by nature in that an application service, although physically hosted in a single location, is accessible to users throughout the world. A user terminal, such as computer 12, need not be specifically programmed to provide any wagering services. Rather, the computer need only be capable of accessing the Internet. A web server 16 preferably accommodates this global platform in the manner illustrated in the block diagram of FIG. 2. Additionally technology now exists which can conform such systems, if necessary, to local or regional laws by limiting the geographic regions from which such systems can legally accept wagers.

FIG. 2 is a flow chart of steps which are preferably performed when a user accesses web server 16. Assuming the web server 16 provides wagering services for contests which may be played throughout the world, the user is prompted to choose a country (or region) at step 32. Once the user has chosen a country, e.g., the United States (or North America), the user is prompted to choose a contest at step 34. For example, the user may be interested in wagering services relating to horse racing, as compared to basketball. Being that the system is global in nature, the user may also be prompted to select a time zone in which he or she is located at step 36. Any time sensitive information provided by the system, e.g., tip off time of a basketball game, is then expressed in the time zone selected by the user. The user may also select at step 38 a preferred language for information to be presented to the user, and any subsequent display is presented to the user in this selected language using known conversion techniques, such as real time translations utilizing translation tables for terms displayed on a web page. Once a user selects a contest, the user is presented at step 40 with the home contest page for the selected contest in the selected country. For example, the user may select between a homepage for horse racing and professional football in the United States.

A user can select from different options presented to the user generally by “clicking” on “buttons” or entering information into “windows” displayed to the user. Any phrase, icon, or the like which is “clickable” may be considered a prompt to the user to make a selection. Providing the user with two “clickable” alternatives is essentially the equivalent of directly prompting the user with a textual prompt to make a selection, e.g., “Please select A or B.” The selection of the user is then transmitted through the Internet by the user terminal to the web server. The generation of these interactive web pages and their design are well known to those in the art of web page design, such as those familiar with programming in the XML, HTML, and JAVA languages.

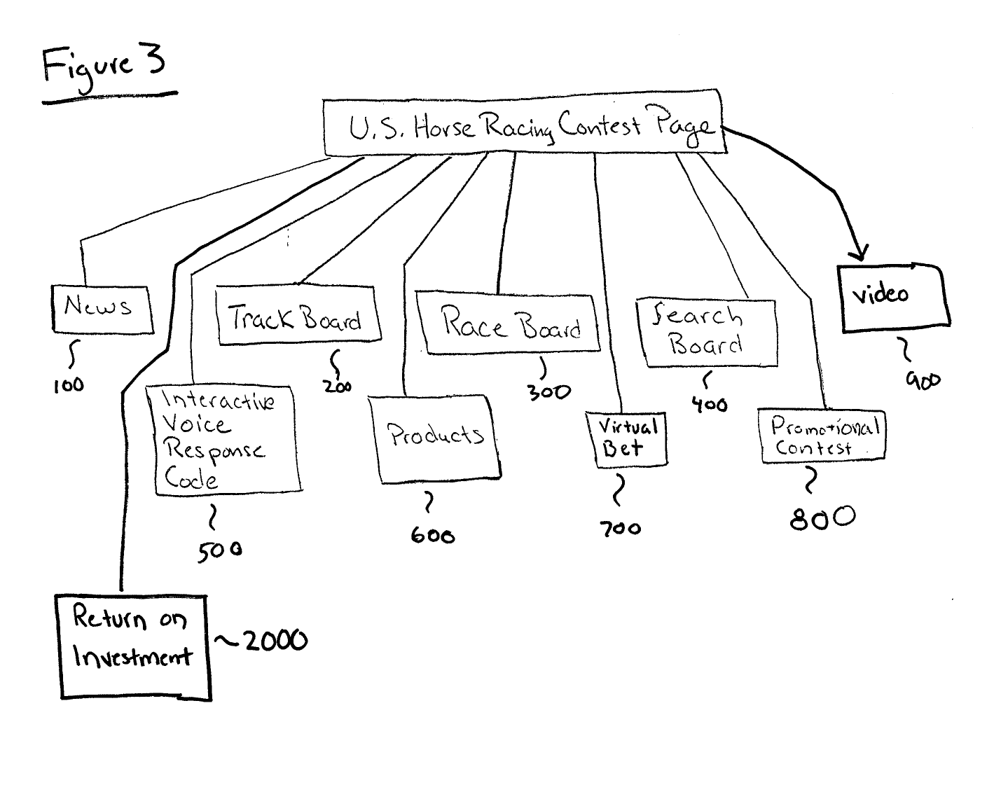

The options presented by an exemplary contest page for a horse racing service are illustrated in FIG. 3. The user may access a news module 100, a track board module 200, a race board module 300, a search board module 400, an interactive voice response (IVR) code module 500, a products module 600, a virtual bet module 700, a promotional contest module 800, a video module 900, or a return on investment module 2000. The details of each of these modules are described hereafter.

The modules are preferably programmed to present user pages or screens which may be manipulated like a “windows” type environment. In so doing, users can easily select options simply by pointing and “clicking” using a device such as a mouse. Users can easily enter data or register a request for data, which is then transmitted to the web server 16 for processing. Also, interactive functionality, such as organizing received data, can be accomplished locally at the user terminal if code applets are transmitted along with a particular “page.” The applets are special purpose programs which accompany a page and are run locally at the user terminal, thereby allowing for interactive applications without requiring further transmissions from and to the web server.

Before describing the modules in detail below, some racing terminology used herein is described:

Class:

Races are listed by class. Some race classes include “allowance,” “claiming,” “consolation,” “derby,” “derby trial,” “futurity consolation,” “futurity trial,” “futurity,” “handicap,” “maiden claiming,” “maiden,” “maiden special weight,” “optional claiming,” “starter handicap,” “starter allowance,” “stake,” “starter,” and “trial.”

Sub-Class:

Races may also be listed by sub-class. The sub-classes typically further classify race classes, such as “claiming,” “allowance,” or “stake” races. An example would be a “grade” sub-class of a “stake” class race.

Race Age:

Races are often limited to horses of particular ages, such as two and three year old's; two year old's and older; three and four year old's; three, four and five year old's; three, four, five and six year old's; three year old's and older; four and five year old's; four, five and six year old's and older; four, five, six, and seven year old's; four year old's and older; five and six year old's; five, six, and seven year old's; five, six, seven and eight year old's; five, six, seven, eight, and nine year old's; five year old's and older; six and seven year old's; six, seven and eight year old's; six, seven, eight and nine year old's; six year old's and older; seven and eight year old's; seven, eight and nine year old's; seven year old's and older; eight year old's and older; and nine year old's and older. Each of these age groups are usually represented with a recognizable age code.

Breed Type:

Races are sometimes limited by “breed type” of the horse entry. Some breed types include “Arabian,” “Quarter Horse,” “Thoroughbred,” and “Paint and Appaloosa.”

Race Sex:

Races may also include a “race sex” restriction if not “open” to all sexes of horse. Some horse sex restrictions include” “colts and geldings,” “fillies and mares,” “colts,” “colts and fillies,” “fillies and geldings,” “fillies,” “geldings,” “horses only,” or “mares only.”

Simulcast Status:

A Race listed for a park may have a simulcast status because the race is being taken as a simulcast from another racing venue.

A block diagram of an exemplary news module 100 is illustrated in FIG. 4. A user is preferably presented with three options at steps 102: view the latest racing news, view older racing news or view archived racing news. If the latest news option is selected by a user at step 104, a list of recent racing news articles is transmitted to the user terminal and displayed to the user at step 120. These articles may, for example, be articles published within the last twenty-four hours or the fifteen most recent articles. The articles provide the latest news on what is happening in the Thoroughbred, Harness, Greyhound, or Steeplechase racing. If the user selects an article, such as by “clicking” on the title of the article at step 122, the text of the article is transmitted to the user from the web server 16 and displayed to the user at step 124. The web server 16 may retrieve the article from the data server 20. Alternatively, the current articles can be locally stored by the web server 16 as they are received from an external data source 18, such as Thoroughbred Times, of Lexington, Ky.

The user may also select an older news articles option at step 104. This option provides the user at steps 114 to 118 access to articles from, for example, the last few weeks in the manner described above for the latest news articles. This option allows the user to view what was previously posted as “latest news.” As the latest news articles are updated, the latest news articles move to the older news option, and the older news articles move to the archived news option, described below.

The news module 100 also preferably allows the user to search for archived news articles when the user selects that search option at step 104. These articles are preferably stored in data server 20 and are accessible to web server 16. The news module 100 preferably allows the user to search for news articles using boolean search techniques at step 106, e.g., “Secretariat AND Kentucky” or “Secretariat OR Triple Crown”. When a search is completed, the web server 16 transmits search results, such as a list of titles of articles that satisfy the search request (if any), to the user terminal for display to the user at step 108. The user may then retrieve a copy of an article by selecting an article, such as by “clicking” on the title of the article, at step 110. The selected article is then transmitted to the user terminal and displayed to the user at step 112.

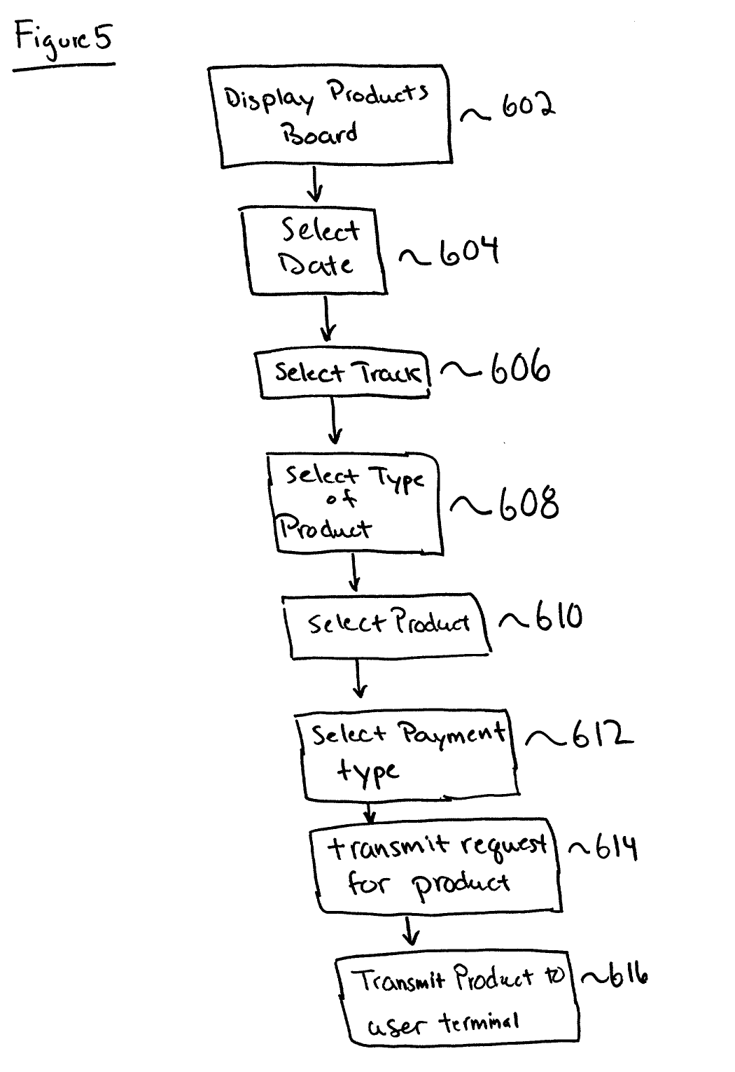

FIG. 6 is a block diagram illustrating the options presented to a user by an exemplary track board module 200. A track board is preferably displayed to the user at step 202. The track board initially presented to the user preferably defaults to the data for the current date (i.e., today's date), but the user is presented the option at step 204 to select a track board for a date in which the user has interest.

Race program data for races are usually available approximately 24 hours in advance of races. Race entry data for races are typically available 48 hours in advance of races. Race program data include data that would generally be available to a wagerer at a park or off-track facility in a race program. The program data generally include a list of current races that are scheduled to be run, a list of current runners (horses, dogs, etc.) or entries for each race and a scheduled jockey for each current entry. Race entry data include the horse and jockey entries for races at listed tracks as of 48 hours prior to race time, and may include morning line odds for the original entries (if applicable). These entries are subject to change as the time draws closer to the race date. For example, an owner may originally enter two horses in a single race with each horse ridden by the same jockey. It should be apparent that as the race time draws nearer, the owner must withdraw a horse or add a second jockey. This decision is typically made at least twenty-four hours (but sometimes less) prior to race day, at which time the race will be listed in a race program. Early horse and jockey entries for races are generally available forty-eight to seventy-two hours in advance of race time.

The race program data, race entry data, and early entry data may include much overlapping information besides the jockey, horse, and trainer for each entry in a race. For example, wagering data included in race, program and early entry data may include the post position of each horse, the combined weight of the jockey and saddle that the horse will have to carry, any additional equipment on the horse (e.g., blinkers), any medication being used by the horse (e.g., Lasix, Bute), the owner of each horse, the trainer of each horse, the opening or morning line odds for each entry, the class of race, the sex, age and breed restrictions of the race, the race distance, and the post time of the race, to name a few.

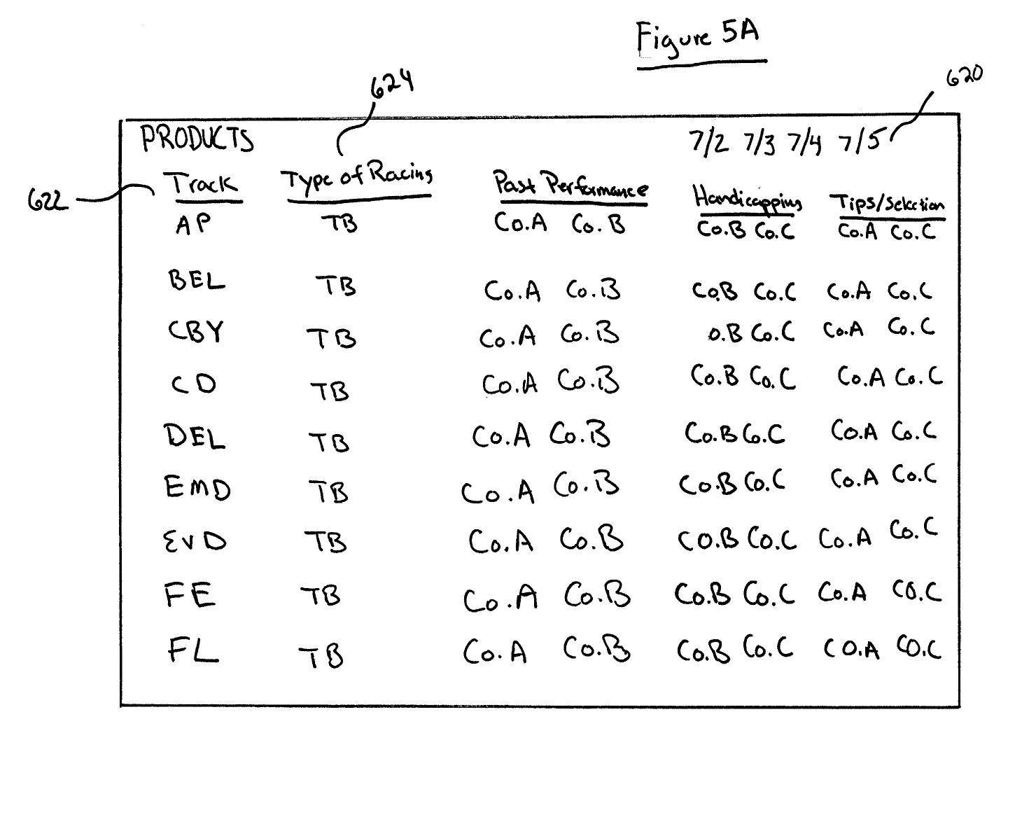

If a user selects a date at step 204 different from the default date, a track board for that date is transmitted to the user terminal and displayed to the user. Referring to FIG. 7, an exemplary format for a track board is illustrated. A plurality of tracks 250 are listed. Abbreviations for the tracks that are standard codes used by the racing industry, full names, or another system, or combination of systems, may be used to list the tracks. For example, “AP” is an abbreviation for Arlington Park and “BEL” is an abbreviation for Belmont Park. The track board also preferably lists the current weather conditions 252 if the present date is selected, or forecasted weather conditions if a future date is selected. The weather conditions for each track are preferably depicted in an easily recognizable graphical format. The weather conditions are preferably updated at predetermined times throughout the day, such as every hour. This is especially helpful when sudden weather changes occur during the course of the day that could affect the track's surface. The weather condition data can be received from an external data source 18 and forwarded to the web server 16 for display on the track board transmitted to user terminal 12. Additional weather data may be accessed by clicking on the graphical condition 252, such as temperature, humidity, dew point, wind conditions, barometric pressure, visibility, etc . . .

Alternatively, there may be a separate weather module where a weather board is presented to the user. The weather board may include a list of all of the tracks and weather conditions at each track. The weather board may be searchable and organizable, i.e., customizable or personalizable, such as by temperature, track, track location, current weather condition, forecasted weather condition, etc . . .

A list of races for each listed track and scheduled for the selected day is preferably displayed along with the track listing 250 and weather condition listing 252. For example, there are six races listed for Arlington Park for July 2. Note, the current date—7/2—for purposes of this example, is shown underlined in FIG. 7. An individual race, and inherently a track, can be selected by a user at step 206 by “clicking” on a race number.

The track board preferably distinguishes the potential statuses of each race in some format to the user. By doing so, the user can quickly identify races having a status in which he or she has an interest. The status of a race may be as simple as whether the race has been run or has yet to be run, or more distinguishing. For example, assume the user has chosen at step 204 the date of July 2 and assume July 2 is the current date (i.e., today's date). This selection may be made on the track board of FIG. 7 by selecting a date 256 corresponding to July 2. Races “1,” “2,” and “3” at Arlington Park (AP) may be highlighted in a color such as green to illustrate that they have already been run and that results for the race are available. If the user were to select any of these races, i.e., clicking on a race number, the results of the race are transmitted to the user terminal and displayed at step 208. It follows that all races for a track board from July 1 (“7/1”) would be highlighted in green because each race was completed the previous day.

Race “4” at Arlington Park (AP) may be highlighted in yellow to illustrate its status that it has not been run, is open for wagering, and live, updated odds are available for the race. If the user selects this race, the available program data and live odds are preferably displayed to the user at step 212. The time to post for each race having this status may also be displayed on the track board to alert the user to the urgency of viewing the program data for the race. Alternatively, race “4” may be highlighted in a color such as gray to illustrate that it has not been run, but wagering has closed on the race, i.e., the race is about to begin or is in progress or awaiting final results. If the user selects this race at step 210, the program data may again be displayed to the user along with a notice that the race is closed for wagering and the closing odds for the race, if available.

Races “5” and “6” at Arlington Park (AP) may be highlighted in another color, such as red, to illustrate that program data are available for the race, wagering on the race has opened, but live odds are not yet available for the race. If the user were to select this race, the program data and morning line odds may be displayed to the user for the race at Step 214.

If the user were to select July 3 (“7/3”/tomorrow's date) on the track board screen, all of the races would be highlighted in yet another color, such as purple, to indicate that program data are available for the race, but the races are not yet open for wagering. The program data, notice of wagering status, and any available morning line odds are displayed to the user at step 216 if the user selects one of these races.

If the user were to select July 4 (“7/4”/two days from the present date), all of the races may be highlighted in another color such as blue to indicate that only race entry data are available and wagering has not yet opened. If the user selects one of these races, the race entry data are displayed to the user along with the morning line odds for the race at step 218. Still further, a July 5 option may be presented to the user and all races may be highlighted in another color, such as orange, to indicate that only early entry data are available for the race. If the user selects one of the listed races, the early entries for the race are displayed to the user at step 220.

A table indicating the significance of each color is preferably presented along with the track board in order to indicate the status identified by each color to the user. It should also be understood that the colors described above in no way limit the invention, but are selected for illustrative purposes only. Further, the statuses of the races need not be distinguished from each other by color, but rather may be distinguished by other means, such as numeric indicators, key words, abbreviations or other distinguishing characteristic.

Additional colors may also be used to identify the statuses of races relative to post time. For example, a color may be used to signify that a race post time is less than thirty minutes away. Still further, a color (e.g., brown) may be used to indicate that a race has been canceled.

The display of the track board of FIG. 7 is preferably dynamically updated from the web server at predetermined intervals. For example, weather conditions 252 may be updated and the colors of the races may change. The highlight of race “4”, for example, preferably changes from yellow to gray when the race's status changes from “open to wagering” to “closed to wagering.”

Once a user selects a race at step 206, wagering data (in this example, data relating to horse race wagering) is displayed to the user. As discussed above, the wagering data may include the status of the selected race (e.g., results available, race closed for wagering, etc . . . ), the results of the race, program data for the race, race entry data, or early entry data. Also, as mentioned, the results data, race entry data, race program data, and early entry data are not limited to just data identifying the status of a race and entries at each race at each track, but also may include other information about the races which are of general interest to racing enthusiasts and typically included in race programs at tracks. Racing data displayed to the user may include other data relating to the contest and include morning line odds, program numbers, program page numbers, owner names, post times, race class, purse value, distance, age restrictions for entries, sex restrictions for entries, weight carried by the horse, post positions for each horse, claim minimum for the race (i.e., the amount the horse entered may be claimed for), equipment restrictions, medication information, breed type, or surface of the track, track conditions (e.g., fast, slow, etc.) to name a few. Despite the status of a race selected by the user, each display for a selected race preferably includes the track, date, race number, post time, class code, purse, distance, age and sex. Still further, the wagering data can indicate to the user which wager or bet types are available for the race. This feature is desirable because not every wager type is accepted for each race.

It should be understood that real time odds when available can be included in the program data display. This feature provides a tremendous advantage over conventional paper programs. The dynamic nature of the presentation of each race's status also provides an added benefit to the present invention over conventional paper programs.

Other possible racing data may include the “Silk” of the jockey entry. Particularly in Europe, a jockey's jersey or “Silk” represents his employer's or horse owner's identity. This information may also be listed along with the jockey, such as in a descriptive textual format or graphical presentation.

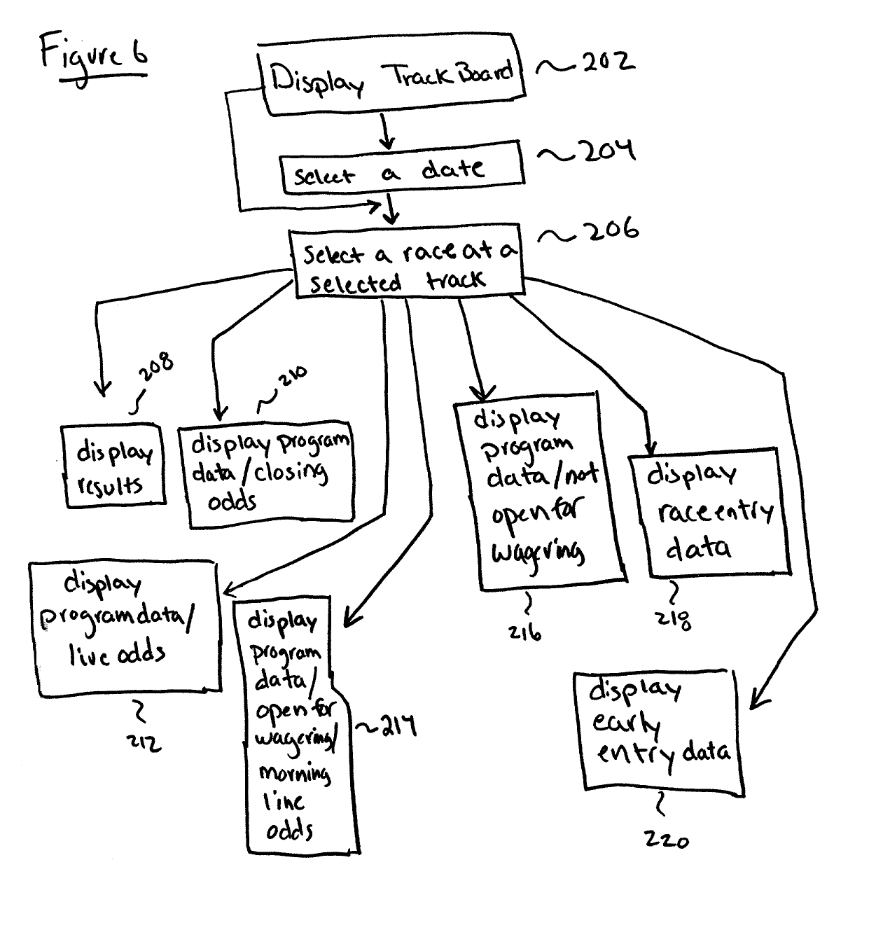

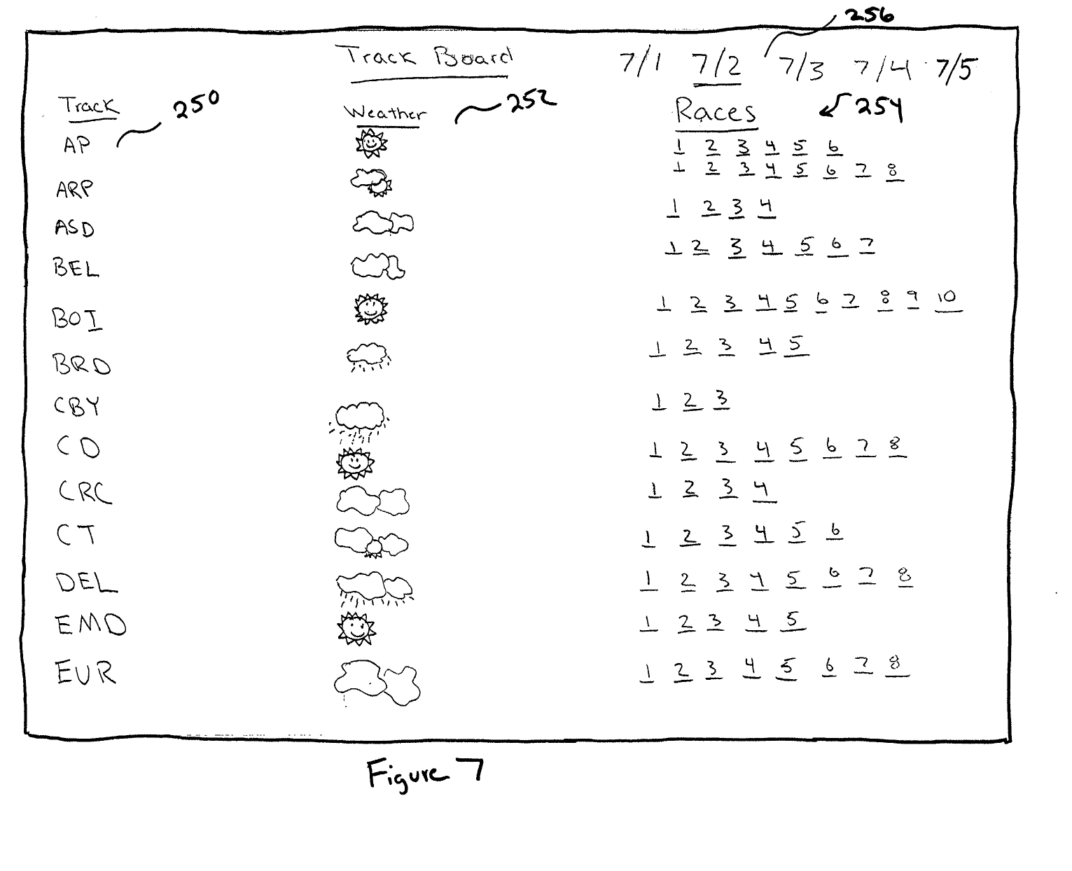

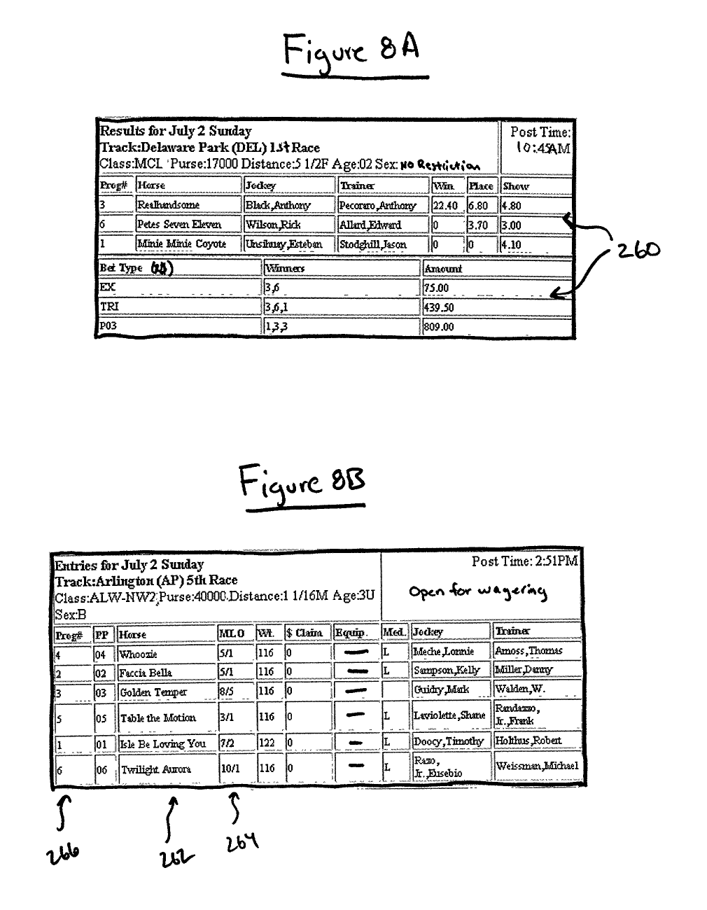

FIG. 8A illustrates an exemplary display for a selected race that has already been run. The display conveys the results 260 of the first race at Delaware Park, i.e., “Realhandsome” placed first, “Petes Seven Eleven” placed second, and “Minie Minie Coyote” placed third. The win, place and show payout results and other payouts for more complex wagers, such as exacta, trifecta, or pick three, to name a few, are also preferably displayed. This information may be obtained by the web server 16 from an external data source 18, such as a totalizator. All payouts are preferably based on a $2 wager (or a $1 wager if the individual track accepts $1 wagers), but the payouts may be calculated for another wager if the user so chooses. Additionally, teletimer data—the time in which each horse finished the race—could be displayed.

FIG. 8A also illustrates that other pertinent racing data for the selected race may be displayed to the user, such as the program number of each entry, the post time of the race, the class of the race, the purse for the race, the distance of the race, and any age or sex restrictions for the race.

FIG. 8B illustrates racing data for a race that is included in the program data and is open for wagering, but for which live odds are not available. The current entries 262 for the race are listed along with the morning line odds 264 for each entry. The program number 266 for each entry is also listed. As can be seen in FIG. 8D, no program number is shown for the first race at Arlington park on July 4 because program data are not available for races that far in advance. FIGS. 8B and 8D further illustrate that the post position (PP) of each entry, weight (Wt), claim amount ($ claim) for the race, equipment (Equip), and medication (Med) may also be listed. A table of abbreviations preferably is displayed along with each display screen to explain any abbreviations used in the screen. For example, the table for FIG. 8B may show that “L=Lasix,” and the table for FIG. 8C may show that “B=Blinkers” for equipment.

FIG. 8C illustrates racing data for a race which is open for wagering and for which live odds are available. The time until post 268 is listed and is preferably updated at periodic intervals, such as every five minutes. This time until post can also be listed next to or in connection with each race number on the track board of FIG. 7 when appropriate, e.g., when the status of the race is open for wagering. Live odds 270 are shown to a user and are again updated at predetermined intervals, such as every minute. These live odds may be forwarded to the web server by a totalizator and then periodically transmitted to the user terminal for display in the board shown in FIG. 8C. The win pool and percentage, the place pool and percentage, and the show pool and percentage are also preferably displayed at windows 272 and are periodically updated. The totalizator is preferably connected to the web server 16 or database server 20 by a serial data link that feeds live odds to the server continuously. The display of these live odds to the user, however, is preferably periodic in nature to permit the user sufficient time to analyze the odds.

A track board allows a user to quickly and easily identify races from a track which the user has an interest. The user can easily identify the status of a race, particularly if the user is looking for a race which is open to wagering. Further, all of the result, program, and race entry data are available to the user in one location. By viewing a single screen, a user is efficiently provided with at least four dimensions of race information for the United States, North America, or other selected region—a list of each track, the scheduled races at each track, the date each race is scheduled, and the status of each race.

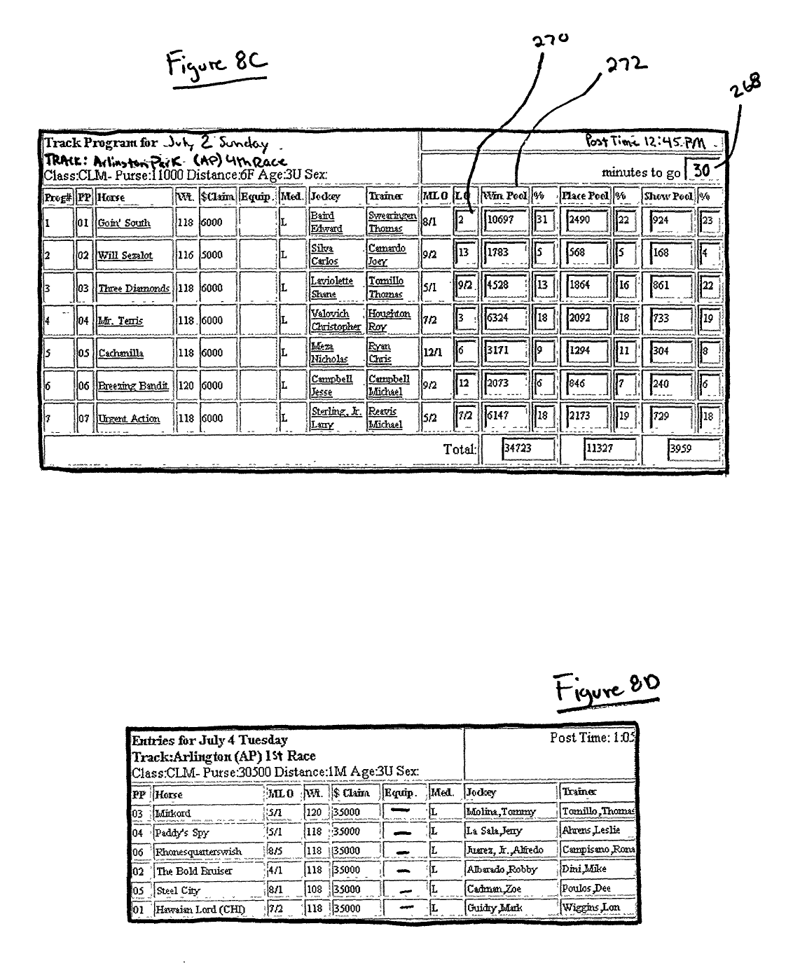

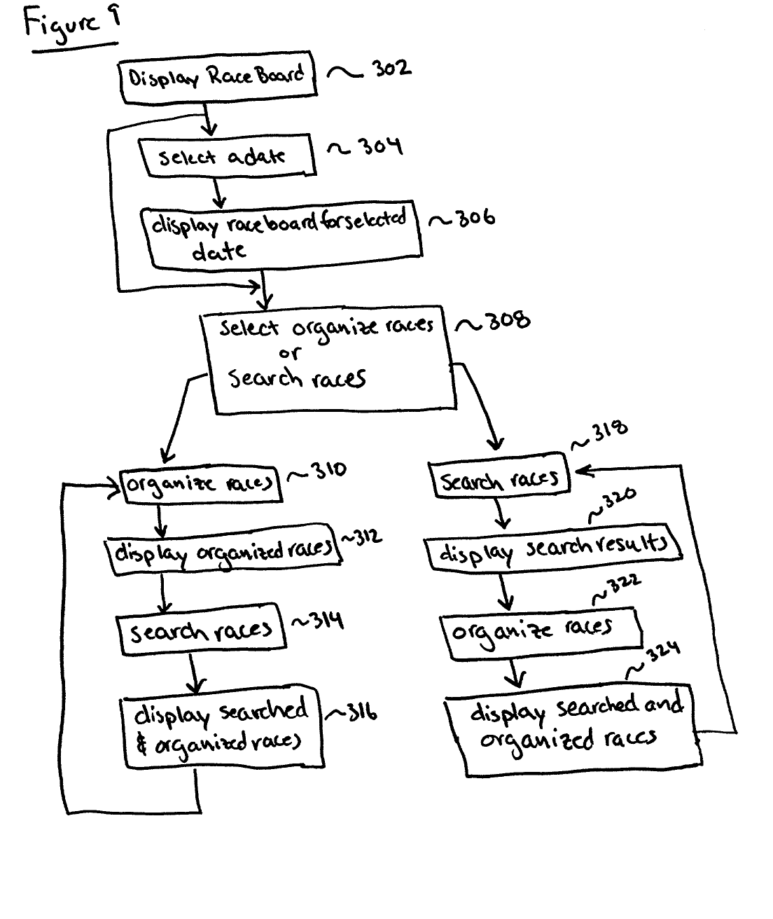

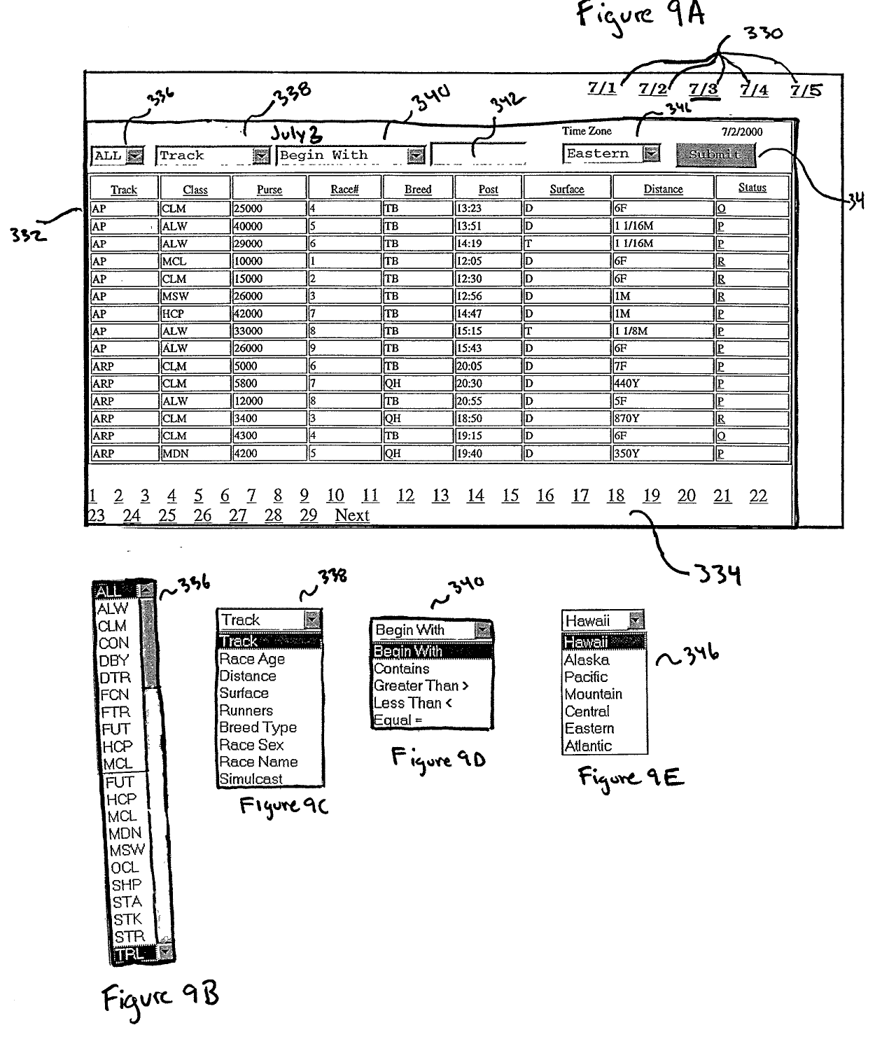

FIG. 9 is a block diagram illustrating the options presented to a user by an exemplary race board module 300 according to the present invention. The race board lists races available for several days with many sortable categories according to the preferences of the user. A race board is first presented to the user at step 302. The user may be prompted at step 304 to select a date, whereby races scheduled for that selected date are presented to the user at step 306. A default race board, such as the race board for the current date, may be transmitted to the user terminal and presented to the user at step 302, or the user may first select a desired date at step 304.

Many races are run in a given country every day. For example, approximately one thousand races are run each day in the United States (approximately 10 races per day at each of approximately 100 race tracks) between thoroughbred, harness, and dog racing. A race board according to the present invention preferably lists all of these races for a user, preferably not at the same time though. The races may be presented in groups of twenty, for example, with the user selecting from fifty possible display groups. Alternatively, a race board page may be presented to a user in which a user may continuously scroll through to a selected race.

The list of races are preferably displayed to the user in a default organization at step 306, such as by alphabetic order of the race tracks, e.g., all the races from tracks beginning with the letter “A” are first displayed, then all of the races from tracks beginning with the letter “B” are displayed, etc . . . At this point, the user is preferably presented the option at step 308 of either organizing the displayed races in a desired organization or searching the displayed races for races having predefined race characteristics, as is discussed below. If the user initially chooses to organize or customize the races at step 308, the race list is organized according to the user's selected parameters at step 310 and is displayed in the chosen organization at step 312. The user may then be permitted to search the organized list at step 314, whereby the search results are displayed to the user at step 316 in the preselected organization. These search results are also preferably reorganizable into a new customized organization desired by the user.

Similarly, if the user initially decides to search the full list of the races at step 308 from the selected date, the list is searched for races having the selected characteristics at step 318 and the search results including a list of races from the original race list having the selected race characteristics are displayed to the user (if any such races exist) at step 320. The user may then preferably be allowed to organize the search results into a desired organization at step 322, whereby the organized search results are displayed to the user in a selected organized fashion at step 324. The user may also choose to refine his or her selected search characteristics or execute a new search of the original race list with new search parameters.

A race board is very helpful for wagerers who look to wager on races having certain characteristics or for persons who otherwise wish to identify those races having predetermined characteristics. A trainer, for example, may have an interest in identifying claiming races for female entries These races are not otherwise easily identifiable from the thousands of scheduled races for which information is available.

FIG. 9A is an example of an exemplary race board page presented to a user. The user can select a race board for a desired date 330. Each horizontal line indicates a race at a track. For example, the first line 332 indicates a race at track “AP” (Arlington Park) which is a claim (CLM) class race with a purse of $25,000. The race is the fourth race at Arlington Park on July 3 and each horse is a thoroughbred (TB). The post time is 13:23 Eastern time, the surface is dirt (D), and the race distance is six furlongs (F). The status of the race is indicated by the letter “O.” The letter “O” can indicate, for example, that the race is open for wagering and program data and live odds are available. It should be apparent that this example now assumes the current date is July 3, being that live odds are available. The status can alternatively or additionally be indicated by a color as described above with the track board module 200.

The race listing of the race board may be organized simply by “clicking” on, for example, “POST.” If “POST” is selected, the listed races are organized by post times, e.g., from earliest to latest post time. Selecting “POST” a second time reverses the order of listing, e.g., from latest to earliest post time. Further, the race listing may be organized by allowing the user to remove columns in which the user has no interest, such as removing the “CLASS” column. Similarly, the user may be permitted to replace a column or add a column displaying a race characteristic which the user does have interest, such as a column indicating number of runners for each race. A check list may be provided along with a displayed board that allows the user to check and un-check those race characteristics the user wishes to have displayed on the board. The option is preferably provided for all board displays. This feature provides for very flexible customization or personalization of wagering data according to an individual's preferences and needs.

The organization feature, even without first searching the race list, may be very helpful to a user. A user may, for example, wish to see the range of purse values for all of the races for the selected date. Indeed, some wagerers prefer to bet only high or low purse races.

The race board shown in FIG. 9A lists only a portion of all of the available races in order to facilitate a comfortable display of the races to the user. The user can select from the non-displayed groups of races by choosing from the remaining groups 334 listed as “1” through “29” and “Next.” As mentioned above, the race board page may be designed as a continuously scrollable page, thereby removing the need for groups 334.

Referring to FIGS. 9B through 9E, possible search options of race characteristics are shown. Pull down window 336 allows the user to select a race board that displays a race list from all available tracks or races within a particular class (e.g., CLM (claiming), CON (conditional), etc . . . ). Pull down window 338 prompts the user to select a race characteristic for which to search the list of races, such as by track, race age limitations, distance of a race, surface of a race, the number of runners in a race, the breed limitations of a race, the horse sex limitation of a race, the name of a race, or whether the race's status is simulcast, to name a few.

After the user has selected a race characteristic, the user may select a preferred search method. Pull down menu window 340 presents the user with possible options. The “Begins With” option allows the user to search, for example, for “Race Names” that “Begin With” the letter “A”. The letter “A” is then typed or otherwise entered into open window 342. The user may also use this option to search for the first digit in a number. The “Contains” option allows the user to, for example, search for a “Race Name” that “Contains” the word “Derby” or a number that contains a selected digit or digits. The “Greater Than,” “Less Than,” and “Equal” options permit the user to search for races having, for example, Purses greater than “10,000” or races that are longer than one mile or “1M.” These options may also be used to search through lists alphabetically, e.g., all race names starting with letters from “k” to the end of the alphabet. The user can also opt to view listed post times as adjusted by a selected time zone 346. When the user has made his or her selection, the selected search can be executed by using the “SUBMIT” button 344.

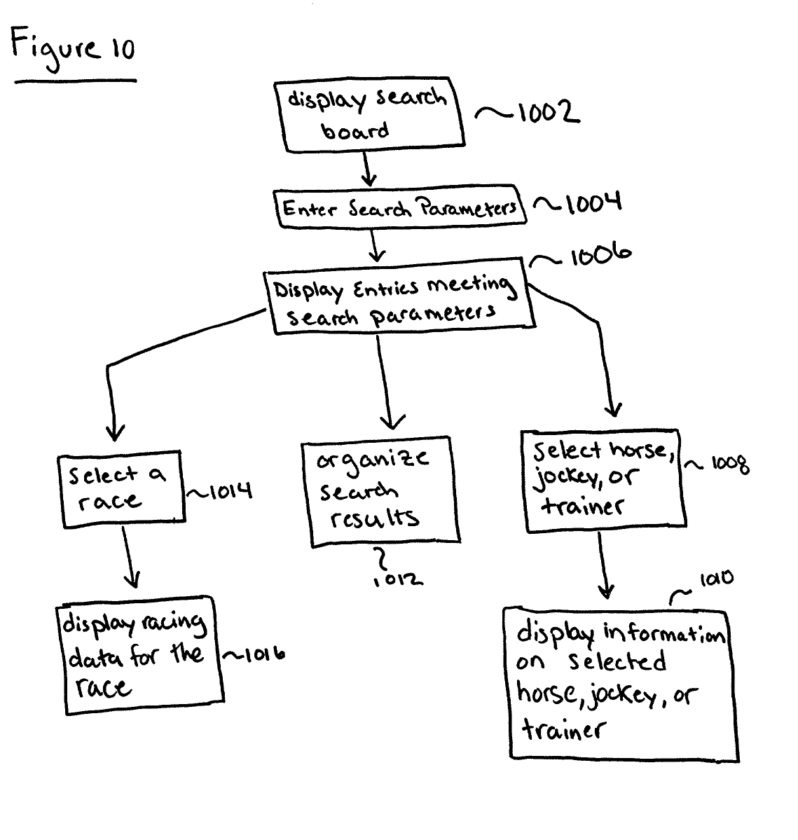

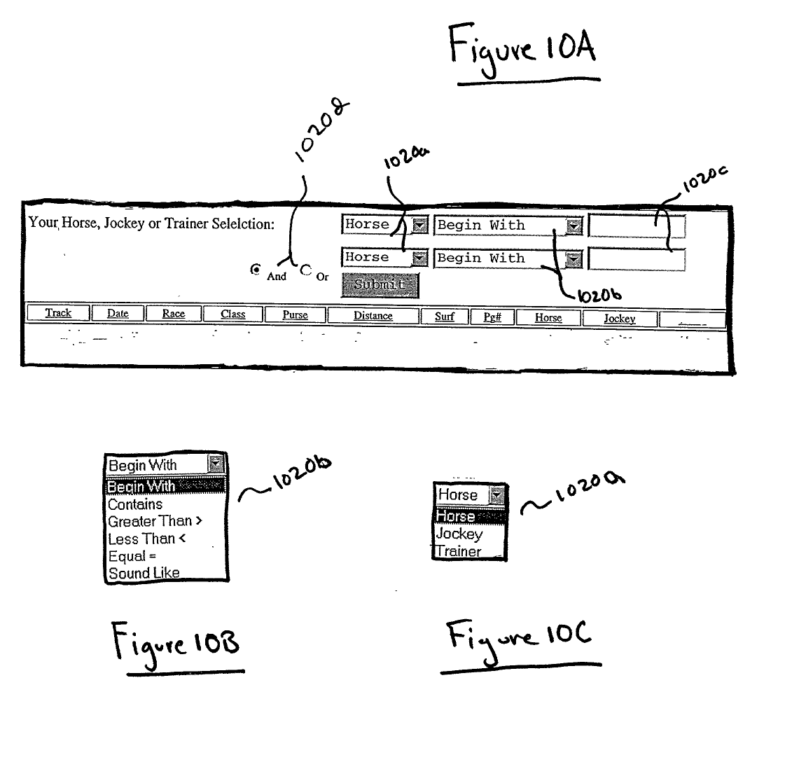

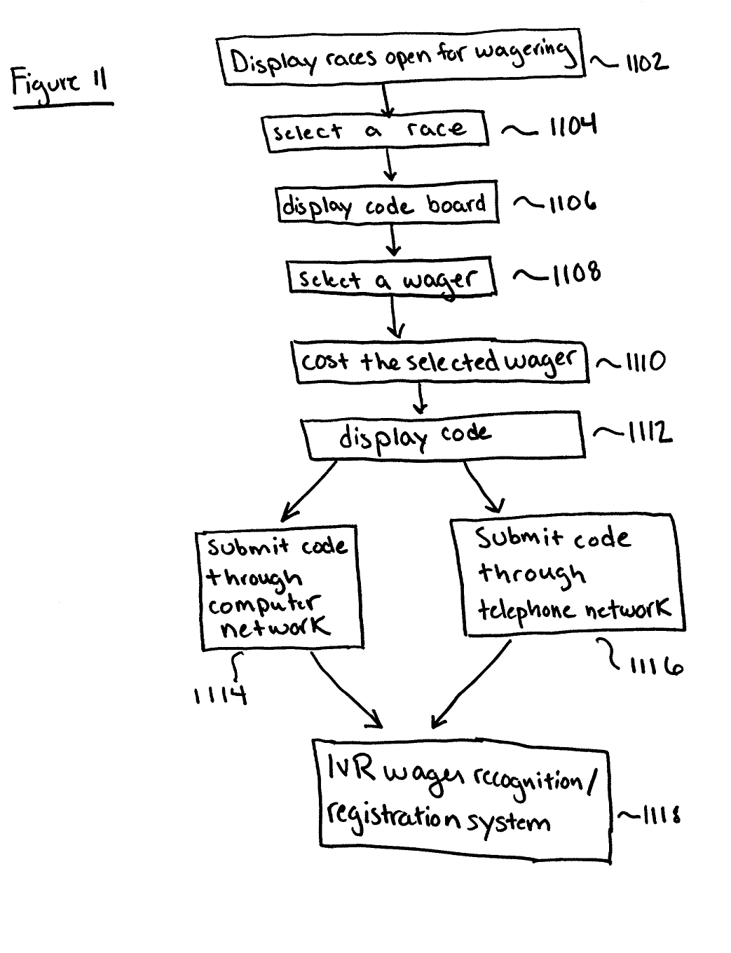

FIG. 10 is a block diagram illustrating the options presented to a user by an exemplary search board module 400. When a user selects the search board module option, a search board is transmitted to the user terminal and displayed to the user at step 1002. The search board prompts the user to select a search, and the user enters his or her selected search parameters at step 1004. The user can then search for specific entries in races, i.e. . . . , for specific horses, jockeys, or trainers, or combination thereof (a particular horse ridden by a particular jockey, etc . . . ).

An exemplary search board is illustrated in FIGS. 10A, 10B and 10C. Windows 1020a allow the user to select a horse, jockey or trainer parameter. A window 1020b then allows the user to select a connector parameter for the parameter entered in window 1020a and a parameter entered in open window 1020c. For example, the user could choose to search a “horse” in window 1020a that “contains” from window 1020b the word “lady” entered in window 1020c.

The search board preferably allows the user to search for entries (horse, jockey or trainer) in combinations. For example, the user can search for an entry in a race including a horse containing the word lady “and/or” (selection window 1020d) ridden by a “jockey” with a name that “begins with” the letter “X.” The search board may also prompt the user to select a third entry parameter, such as a horse satisfying a selected parameter ridden by a jockey satisfying a selected parameter and trained by a trainer satisfying a selected parameter. Additionally, a fourth variable could be used, such as “owner.”

Once the user has entered his or her selected search parameter at step 1004, the parameters are transmitted to the web server. A database server 20 then searches stored racing data for entries that satisfy the requested search. The racing data may include early entries in races, race entries, or program entries. The racing data may also include past races, i.e., entries for which results are available.

Once the search is complete, the search results are transmitted to the user terminal and are displayed to the user. The results preferably identify the race(s) in which the selected horse, jockey, trainer, or combination thereof can be found as entries.

Even if a search was conducted only for, for example, horses names containing the word “lady,” the horses that satisfy this search all have jockeys and all have trainers. Therefore, each horse's jockey and trainer is also preferably listed along with the horse name. The user at step 1008 can select a particular horse, jockey or trainer (e.g., by “clicking” on the name of the entry) and statistical data for the selection is transmitted to the user terminal for display to the user. For example, the jockey's career record and career winnings may be displayed at step 1010 to the user. A picture, video, or audio of the selected horse, jockey or trainer may also be transmitted to the user terminal and displayed to the user with the user terminal.

Other statistical data may include year-to-date data for a horse, such as the number of starts for the horse, the number of wins, the number of seconds, the number of thirds, earnings, horse breed, color, and morning workout information. Horses generally do workouts in the morning. Clockers clock the workouts and report the time, e.g., the time it took a horse to run a lap around a track. Horses generally run races every seven to ten days. Therefore, workout information may be very valuable to an interested user when, for example, the horse has not run in forty days or the horse is recovering from an injury. Similar annual data can be provided for the jockey and trainer. To this end, the system is also preferably fully integrated in that any time a horse, jockey, or trainer name is listed, regardless of the module, this information may be accessed by simply “clicking” on the name.

Along with the horse, jockey and trainer identification, each search result may be listed along with other information, such as a track, date, race, class, purse, distance, Silk, surface, and/or page number in a program, or combination thereof. Assume a search was conducted for a jockey named “John Smith.” The search results may show that John Smith is the jockey in the fourth and sixth races at Belmont on July 10. These results are preferably organizable as described above with the race board, such as by clicking on “Purse” to organize the results by purse value.

If the user then selects at step 1014 the fourth race (e.g., by clicking on the “fourth race” display) racing data for that race are then displayed. If the race has already been run, a display such as shown in FIG. 8A may be displayed. Similarly, if the sixth race has not been run, is open for wagering, and live odds are available, a display such as shown in FIG. 8C may be transmitted to the user terminal and displayed.

The search module described above allows a user to quickly and efficiently identify entries of interest. A user may, for example, wish to know each race in which a known “hot” horse or jockey is participating.

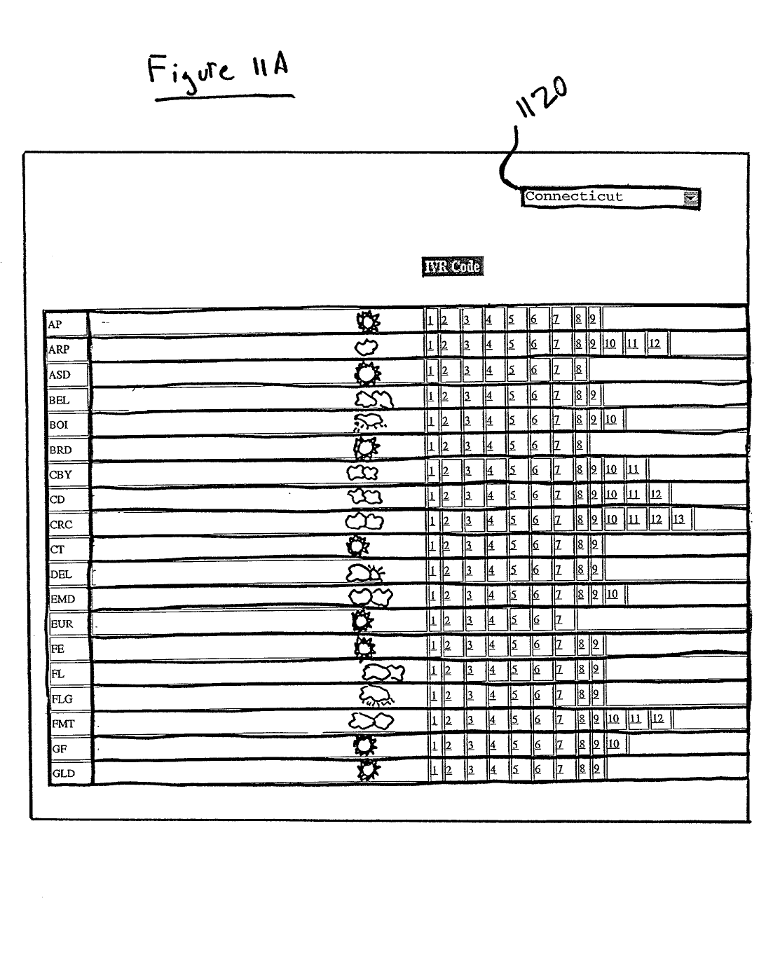

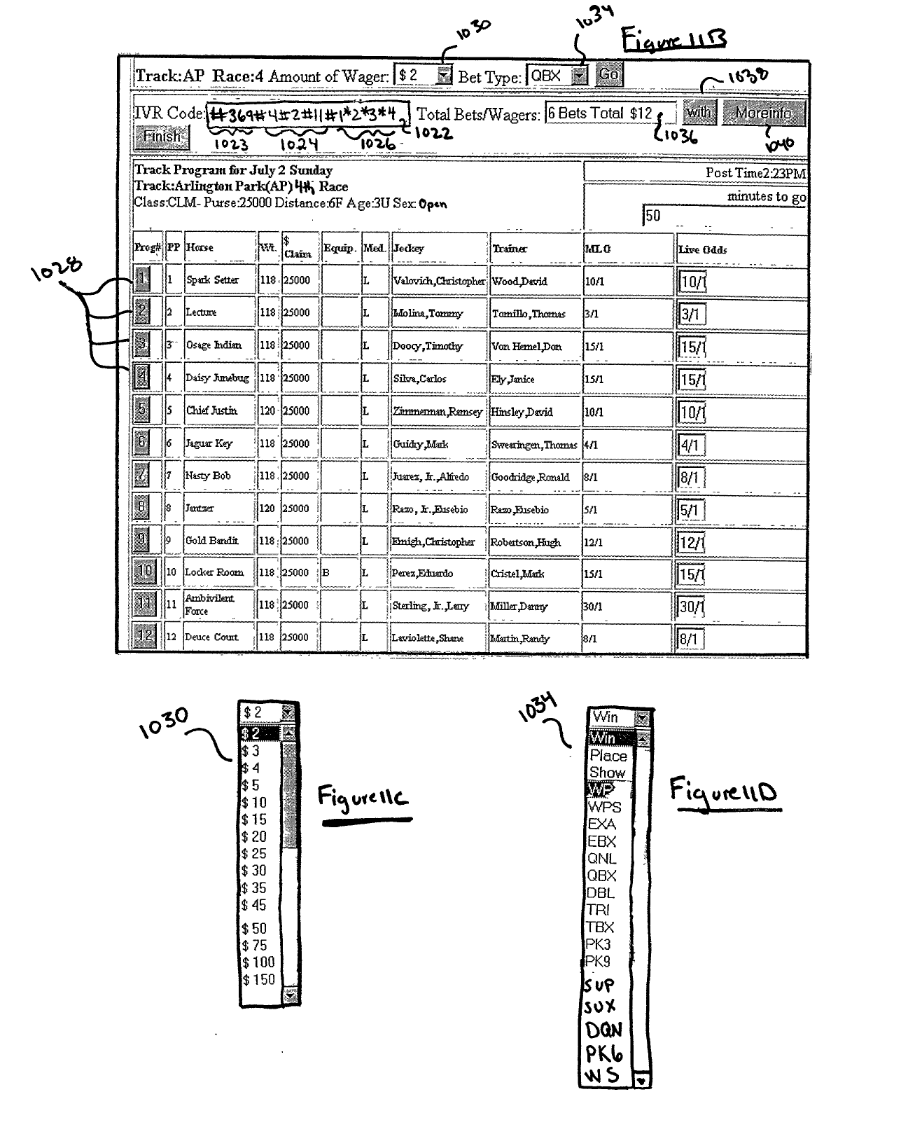

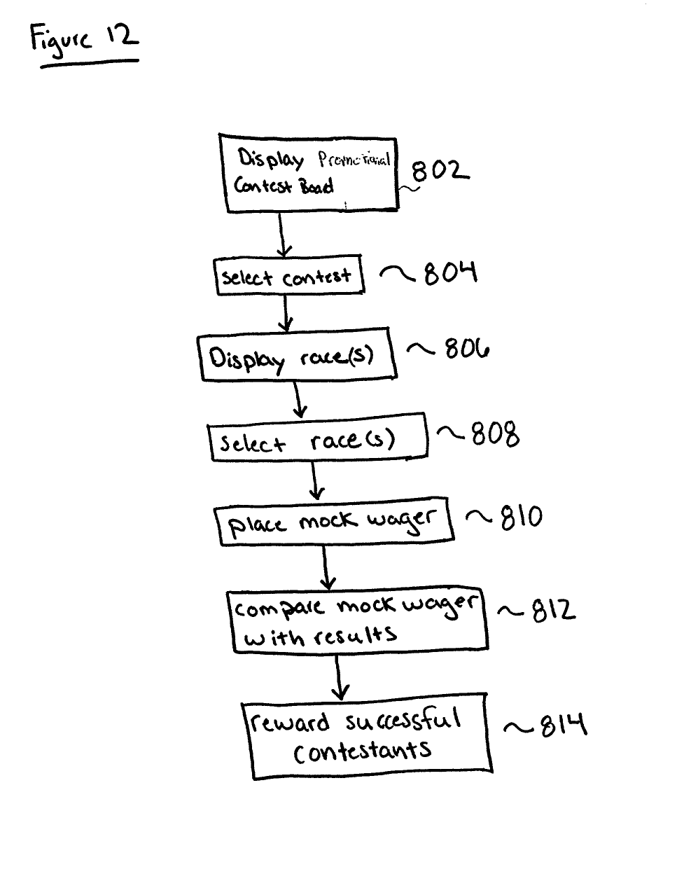

FIG. 11 is a block diagram of options presented to a user by an exemplary code module, and more specifically by an exemplary interactive voice response (IVR) code module 500. A list of tracks and races at the tracks are displayed to the user at step 1102. The list preferably includes only races that are open for wagering. An example of an exemplary board listing these races is shown in FIG. 11A. The list is similar to the track board of FIG. 7, only the races are preferably only those races open for wagering. The board offers the user the option of selecting the wagering system in which the user has an interest through pull down window 1120. For example, a telephone wagering system 22 in Connecticut may use a different code system to represent wagers than a telephone wagering system 22 in Philadelphia.

The user selects a race at step 1104 from the board of FIG. 11A, and a code board is displayed to the user at step 1106. An example of an exemplary code board is shown in FIG. 11B. The board provides much of the same racing information described above as shown in, for example, FIG. 8C. The code board displayed in FIG. 11B illustrates that the third race at Arlington Park on Sunday, July 2 is open for wagering and that live odds are available.

The code board also prompts the user to select a wager. The board of FIG. 11B illustrates in IVR code windows 1022 and 1036 that a wager has already been chosen. An IVR code is displayed in IVR code window 1022, and portion 1023 containing the code for the selected track (e.g., Pound 369 (“#369”) represents Arlington Park). Portion 1024 is the portion of the code identifying the race number (pound 4 (“#4”)), the wager amount (pound 2 (“#2”)), and the wager type (pound 11 (“#11”)). Portion 1026 of the code in window 1022 indicates the program numbers of the horses selected by the user at step 1108, i.e., horse program numbers 1, 2, 3, 4.

The following is an example of the steps which may be executed to select a wager using the code board of FIG. 11B. The user first selects the amount of her wager from pull down window 1030 (also shown in FIG. 11C). Once the user selects the wager amount, the user can select her desired “bet type.” The user selects a bet type from pull down window 1034. Potential wagers are shown in FIG. 11D and may include win, place, show, win/place, win/place/show, exacta, exacta/box, quinella, quinella/box, daily double, trifecta, trifecta/box, pick 3, pick 9, superfecta, superfecta box, double quinella, pick 6, or win/show, to name a few. Once the bet type is selected, the user selects the “Go” button, and the portions 1023, 1024 of the code are appropriately displayed in window 1022.

FIG. 11B shows that the user has selected a quinella/box wager with the 1, 2, 3 and 4 horses (portion 1026 (#1*2*3*4) of the IVR code). The horses may be selected for the wager by pressing the appropriate program number buttons 1028. Window 1036 displays the cost of the user's selected wager. This feature is particularly helpful when a user has selected a complex wager such as a quinella/box wager. A 2$ quinella/box wager is actually 6 bets for $12 dollars because of all of the possible combinations. Essentially the user has placed wagers on horse combinations 1&2, 1&3, 1&4, 2&3, 2&4, and 3&4. As a further example, a trifecta box is a trifecta wager where all possible combinations using a given number of horses are bet upon. The total number of combinations can be calculated according to the formula x³−3x²+2x, where “x” equals the number of horses in the box. The sum of the formula is then multiplied by the amount wagered on each combination. This wager type is quite difficult, or at least time consuming, to cost by hand.

The “With” button 1038 allows the user to separate horses when the user is using more than one horse as a portion of a wager. For example, a user may want to bet an exacta with the #1 horse finishing first and either the #2, #3, or #4 horses finishing second. The user can first select the #1 horse and then select the “With” button, followed by selecting the #2, #3 and #4 horses. Additionally, a “ALL” button may be included which allows the user to combine all of the horses with a selected horse in a bet, e.g., an exacta bet with the #1 horse and each of #2-#12 horses.

The “more information” button 1040 allows the user to view odds data besides that displayed in FIG. 11B. For example, selecting the “more information” button 1040 preferably displays the pool and percentage information shown in FIG. 8C.

Once the user has selected her bet and the cost of the wager is displayed to the user at step 1110 and the code is displayed to the user at step 1112, the user may then use the code to place the selected wager. If the code is an IVR code, the user may use a conventional touch tone telephone 24 at step 1116 to enter the IVR code, i.e., press “#369#4#2#11#1*2*3*4” keys, and transmit the code as analog tones through telephone network 26 to a receiving telephone wagering system 22 or through Internet 14 using voice over IP protocol. The telephone wagering system 32 preferably includes an IVR receiver which translates the tones back into the code. The code is then compared against a look-up table to identify the wager which has been placed by the user. This is preferably automated and controlled by a programmable computer.

Alternatively, the user could transmit the code in a digital format through computer network 14 to web server 16. Web server 16 may forward the digital code 16 to the telephone wagering system 22, such as through a leased line, and the digital signal may be converted into an analog tone for recognition by the telephone wagering system 22. Further, the telephone wager system 22 may include software and hardware capable of recording the wager directly from the transmitted digital code.

Of course, the user preferably has an account with the telephone wagering system or otherwise pays for the wager. The account is preferably a single account which may be used for Internet, telephone, and in person wagering.

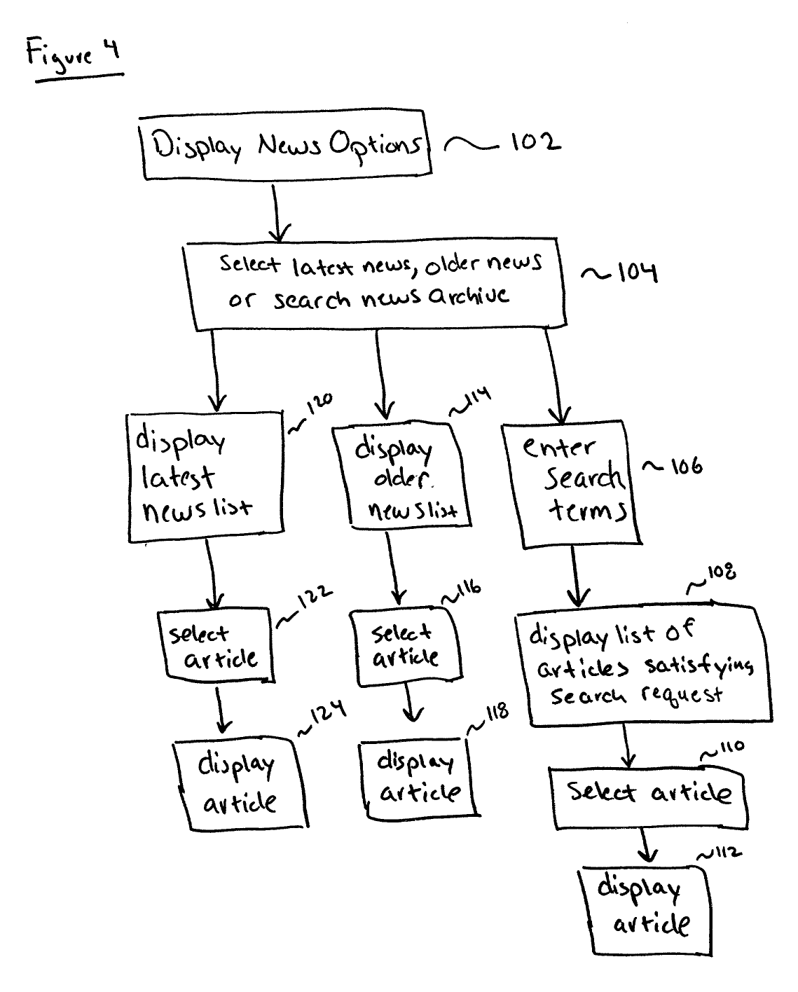

FIG. 5 is a block diagram of options presented to a user by an exemplary product module 600. FIG. 5A is an illustration of an exemplary product board displayed at step 602 when a user selects the “products” option from a main menu. As shown in FIG. 5A, the user can select a date 620 for which products are available at step 604. A product board for the current date is preferably displayed by default, but product boards for other dates may be displayed by selecting the desired date.

The product board preferably displays a list of tracks 622 and the type of racing at the track (e.g., “TB” is thoroughbred racing). The product board also preferably displays the products that are available for each track for selection by a user at steps 606, 608, 610. Examples of products that are popular with horse wagerers are “Past Performance” products, such as those offered by Bloodstock Research Information Services and Daily Racing Form Inc., “Handicapping” products, such as those offered by Autotote Corporation, Bloodstock Research Information Services, and Thoro-Graph, and “Tips/Selection” products, such as those offered by Bloodstock Research Information Services. These products are preferably all offered to the user at one convenient location (i.e., at one page) and from a plurality of different product vendors. The user can select a product or combination of products by simply “clicking” on the company name under the desired product type, and the user is then preferably prompted to select a payment type at step 612.

Payment may be made by, for example, credit card, from a wagering account, from a dedicated account for products, or from a promotional account where a user has earned or otherwise accumulated “points” which are redeemable for products. The product could, of course, also be free to subscribers. Once the user selects a payment method at step 612, a request for the selected products is transmitted from the user terminal at step 614. The request may be a request transmitted to web server 16. Web server 16 may retrieve the products from a data server 20 or forward the request to a vendor's computer system for retrieval of the product and forwarding to the user terminal 12. Alternatively, the selection of the product may be a link to a server maintained by, or for, a company whose product is selected. That company may then directly transmit the selected product through the Internet 14 to the user terminal 12 at step 616. The user may then display the product on a monitor connected to the user terminal, print the product, or otherwise display the product. The product, if not saved by the user, is preferably accessible to the user through the system at later times for no additional charge.

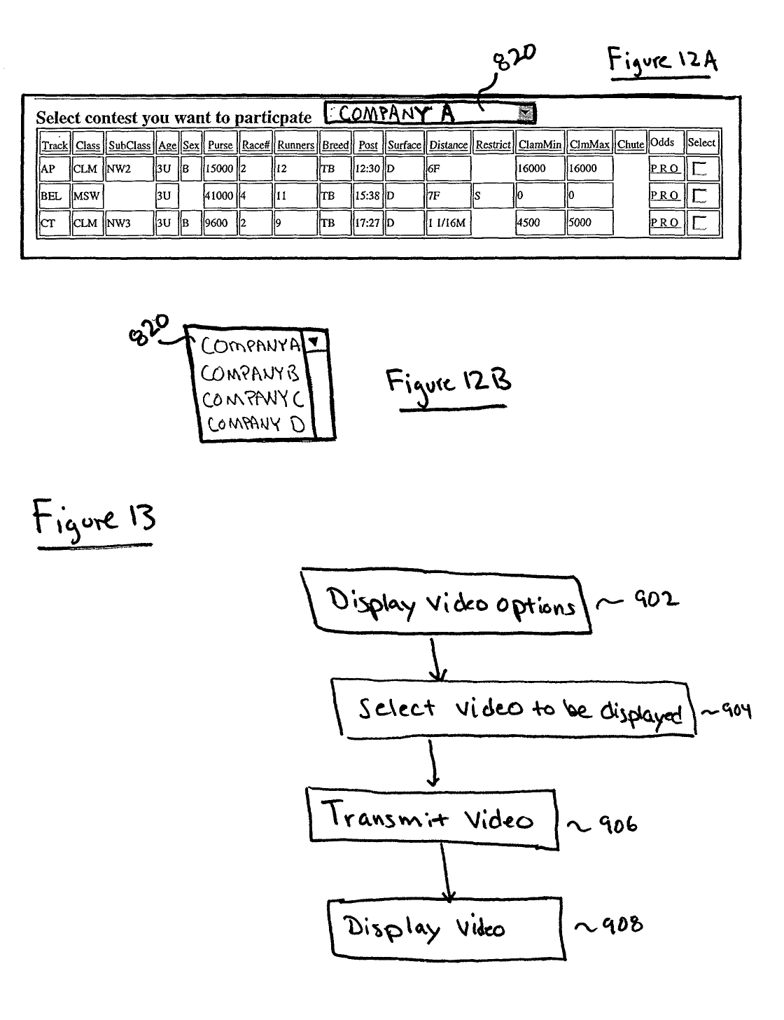

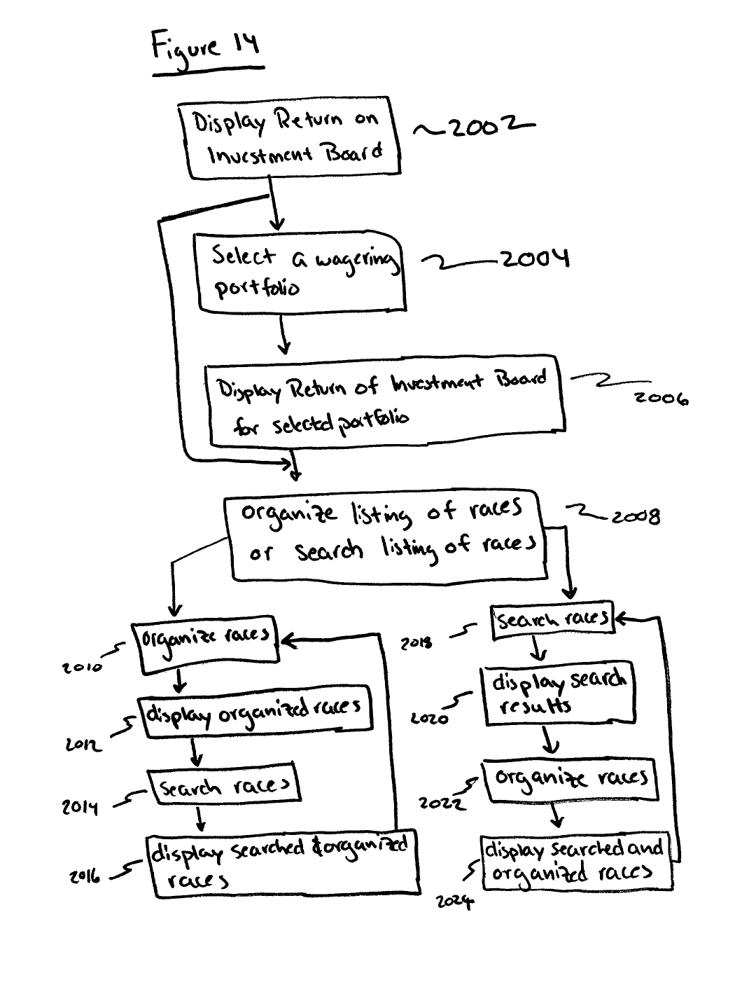

FIG. 12 is a block diagram of the option presented to a user selecting an exemplary promotional contest module 800. A promotional contest board is displayed to the user at step 802 and as shown in FIG. 12A. The user may be prompted to select from a list of a plurality of promotional contests or games at step 804 where the contests are being run by, for example, a single hosting company on behalf of a plurality of different companies as shown in pull down window 820 of FIGS. 12A and 12B, or by a single hosting company under different contest names. Once a promotional contest is selected, a list of races included within the promotional contest is displayed at step 806, such as the three races shown in FIG. 12A for the “Company A” contest. Alternatively, the wager amount for each potential wager (e.g., 2 bets) may be set by the contest rules. The user can select at step 808 one or more of the displayed races, and the user can then place a mock wager at step 810.

The mock wager may be placed with points representing mock or play money and accumulated by the user (as described above) or each contestant may be provided with a set number of points for participating in the promotional contest. Alternatively, the wager amount for each potential wager (e.g., 2$ bets) may be set by the contest rules. The user may acquire points based upon his or her wagering habits or by another business rule. The user may then use the points as money to wager on the selected race. The results of the race may then be compared with the user's wager at step 812, and the a payout of points to a user account may be made at step 814. The payout may also be in the form of promotional merchandise or the points may be redeemable for merchandise, cash, or other reward. The results of the contest comparison at step 812 are preferably displayed to the user, such as in a chart comparing the actual results of each race selected by the user for a mock wager and the user's mock wager selection.

Alternatively, the contest may not require a point system, and, as an example, users can compete against each other to see who can pick the most winners in one twenty-four hour period or for races selected for the contest with the winner being rewarded with a prize. The user may also compete against each other to see who can generate the largest return on a fixed sum of money. The users are preferably given the freedom to select from any number of wager types (e.g., exactas, trifectas, etc.) Further, the promotional contest rules may dictate, for example, that anyone who selects the correct finishing order of the entries in a selected race or races wins a prize, such as a trip oracar.

The instructions for the selected promotional contest are preferably displayed to the user either upon request by “clicking” on a rules button or automatically. In one exemplary embodiment of the present invention, the rules are displayed to the user as scrolling text along with the promotional contest board for the selected promotional contest.

The user may also be permitted to place mock wagers on any available race by selecting the virtual bet module 700. For example, a user who is a new member may be provided one hundred free points, representing one hundred pretend dollars, and the user can use the points to place mock wagers on races, payoffs for which are credited to the user's virtual account. A virtual totalizator may be programmed, i.e., a totalizator simulator, to pay the user the correct amount based on the final odds for the race and the user's wager type (e.g., win, exacta, etc . . . ). These odds may be used from the totalizator running the particular race (even though the virtual bet does not affect these odds) or a virtual totalizator may be programmed to calculate its own live, changing odds based on just the virtual bets it receives. The points paid by the virtual totalizator to the user's virtual account may then be redeemable or be used solely for educational purposes, i.e., to permit the user to hone or test his or her wagering skills. A user may also be charged (e.g., via a credit card account) to add more virtual dollars to his or her account. These virtual dollars may then be wagered for entertainment purposes or to hone wagering strategies in connection with the return on investment module 2000 described below.

An exemplary video module 900 allows a user to request video of a contest, such as a horse race. The user is preferably prompted at step 902 to view either archived or live videos. The user may, for example, be prompted to view a stored race video clip of a race when the user accesses the results of a race. Alternatively, the user may request a race video clip from an archival list of race videos, such as for research purposes. Similarly, the user may be prompted to view live video of a race after the user places a wager on a race or after the user accesses program data for the race.

The user selects one of the options presented to the user at step 902 and a particular race video at step 904, and the selected video is transmitted to the user terminal of the user at step 906 and displayed to the user by the user terminal at step 908. If the user selects an archival video, a race video clip that is stored, for example, at the data server 20 or stand alone video server 21, is transmitted to the user terminal through computer network 13 as a complete file for local storage and viewing by the user using appropriate software at a later time, or the video may be streamed to the user terminal through the computer network 14 for display to the user using software applications, such as Microsoft's WINDOWS MEDIA PLAYER or Real Network's REALPLAYER. Audio may also be included.

If the live video option is selected by the user, the video may be received by video server 21 or data server 20 from a video source such as a simulcast feed, encoded at appropriate transmission rates, and streamed to the user terminal. The video may then be viewed by the user substantially as it is received, although allowing for appropriate buffering to provide quality video display and audio.

Much of the wagering data presented to the user by the modules of the present invention described above overlaps, at least in part, from module to module. As an example, program data may be accessed from the track board module 200, the race board module 300, and the search board module 400. Each module, however, presents the user with an efficient and unique method for accessing this information, depending in part upon the user's individual needs, preferences, and selection criteria. Also, each module may cross-link to other modules. For example, a link to the IVR code module may be provided each time program data for a race which is open for wagering are accessed by a user.

As mentioned, the present invention is not limited to horse racing, or even racing contest services. Rather, the present invention may be used in connection with other contests, as described above, such as United Stated professional football (e.g., the National Football League (NFL)). The modules described above may provide similar options to a user as the above described embodiment of the present invention. A news module may present a user with the latest, older and archived news articles relating to the NFL. A NFL football board may list all of the football games for a given week along with opening odds, live odds, weather conditions, spreads, injuries, lineups, records, team and individual statistics, and the like. All of this data may be searchable and organizable according to a user's preferences. The user, for example, may be interested in identifying all games with double digit spreads. The user may select a wager and the code for the wager may be generated and displayed to the user. The wager may be costed for the user once selected in a number of ways, such as displaying a notice like “the Philadelphia Eagles must beet the Dallas Cowboys by 5.5 points for you to win your wager” or “the Philadelphia Eagles must beet the Dallas Cowboys for you to win $92 on your $100 wager.” This feature may be particularly beneficial to show a beneficial to show a user potential outcomes for complex bets, such as reverses. Likewise, football related products, e.g., scouting reports or past performance reports disclosing trends such as a team's record in home games after a Monday night game, may be offered to the user, and promotional contest and virtual bets, such as football pools, may be provided.

It should also be understood that the displays of various boards generated by the modules of the present invention are only examples of possible display formats. Other displays may be presented to the user while still providing the user wagering data in an exemplary fashion according to the present invention.

The return on investment module 2000 provides a user with a very powerful wager tracking and analysis tool. The user, as described hereafter, can access user wager data pertaining to wagers that the user has placed, as well as racing data pertaining to the races on which the wagers were placed. The return on investment module 2000 may be utilized to access this compiled user wager data and racing data, to quantify the success the user is enjoying (or not enjoying) in his or her wagering endeavors, and to fine tune wagering strategies. The racing data and user wager data are searchable, allowing the user to retrieve and organize his or her wagering history in a customized fashion.

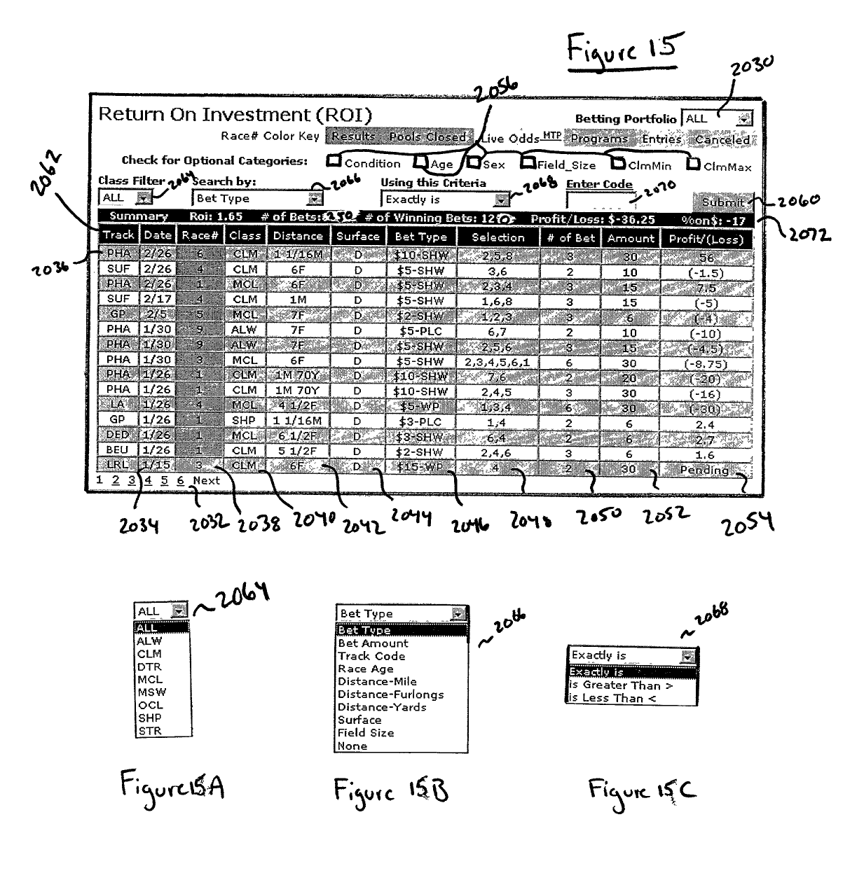

FIG. 14 is a block diagram of the options presented to a user by an exemplary return on investment module 2000. When the module is accessed by the user using a user terminal, a return on investment board, such as the board shown in FIG. 15, is transmitted through computer network 14 and displayed to the user with user terminal 12 at step 2002. The board may be transmitted as a web page for example for display by a browser resident on a thin client.

The return on investment board preferably defaults to list all of the races on which the user has placed a wager, in essence defaulting to show a complete wagering history of the user. The user, however, is also provided the option at step 2004 to select a specific wagering portfolio. The user may select from, for example: a combined portfolio which includes wagering data pertaining to all of the wagers placed by the user (regardless of the venue or method); a virtual bet portfolio which includes user wager data pertaining to mock wagers that the user placed via virtual bet module 700; an IVR portfolio which includes user wager data pertaining to wagers placed or coded by an IVR module 500; an Internet wagering portfolio which includes user wager data pertaining to wagers placed with a totalizator directly through the Internet (if legalized within a specific jurisdiction); an off-track wagering portfolio which includes user wager data pertaining to wagers placed by the user at off-track betting locations; or a live wagering portfolio including wagers placed by the user in person at a race track or tracks. The user may also create his or her own portfolio or sub-portfolio having user defined characteristics, e.g., a portfolio of wagers placed at Philadelphia Park or at a specific off-track wagering locations. The wagers included in a portfolio selected by the user are displayed at step 2006 and are preferably shown as a listing of races and associated racing data and user wager data as described below in connection with FIG. 15.

The user is preferably prompted by the return on investment module 2000 at step 2008 to organize or search the listed races based upon racing data associated with each listed race and user wager data for each wager placed by the user on the the races. If the user chooses to organize the listed races at step 2008, the list of races is organized according to a parameter selected by the user and the organized list is displayed at step 2012. This list may also be searched at step 2014, and an organized search results listing of races is displayed at step 2016. Likewise, if the user decides to search the race list at step 2008, the list is searched for wagers that satisfy the user's selected search parameters and the results of the search are displayed to the user at step 2020, typically as a narrowed list of races. The user may decide to organize the listed results at step 2022, and an organized search results list is displayed at step 2024.

It should be apparent in light the following discussion of the return on investment board of FIG. 15 that the return on investment module 2000 functions in a user friendly and customizable manner in much the same way as the track board module 200, race board module 300, and search board module 400. Referring to FIG. 15, an exemplary return on investment board is shown. Pull down window 2030 provides the user the option of selecting a specific wagering or betting portfolio as described above. The exemplary board shown in FIG. 15 shows “ALL” in window 2030, signifying a portfolio including user wager data for all wagers placed by the user. It should be apparent that an individual wager is placed on an individual race (or series of races) and can be associated and listed in connection with the individual race(s), and therefore, in connection with racing data specific to that race(s). The user's wager may be displayed as a listing of races on the return on investment board in either a scrollable format or in multiple screens (e.g., by selecting the screen identified by selectable numbers 2032). As shown, the list of races also defaults to a chronological order by the date 2034 that the wager was placed or the race was run.

The racing data for each race upon which the user has placed a wager is available to the return on investment module from data server 20 and/or external data services 18 as described above in connection with the other modules of the exemplary wagering system 10. This feature is particularly beneficial when a user elects to establish a wagering portfolio directed to wagers that the user has placed at off-track locations or in person at a track, and therefore, not directly through, for example, an IVR module 500 or virtual bet module 900 of wagering system 10. The user need only enter a minimum amount of user wager data into a data entry interface (not shown) of the return on investment module 2000 (e.g., the wager type, the wager amount, the entries selected by the user, and a race identifier identifying the race number, park and race date), and the return on investment module 2000 can retrieve and associate with the wager any racing data pertaining to the race and results data for the race from data server 20 and external data services 18. The user can enter this wager data through a data entry interface screen or the data can be downloaded from an external source, such as a user's totalizator account or other database or from another source, such as an electronic medium (e.g., a diskette).

Racing data displayed for each race may include, for example, race entry data for each listed race, such as an identifier for each horse entered in the race (e.g., a program number or horse name) and each entry's respective jockey, trainer, and/or owner. Displayed racing data may also include specific characteristics of each race, such as race class, race sub-class, track name, track code, race age limitation, race distance, surface type, number of runners, purse amount, claim amount, equipment used on each horse, medication(s) used by each horse, breed limitation, horse sex, claim minimum, claim maximum, status of race, weather conditions, or a combination thereof. The status of each race on the race listing may also be indicated by, for example, a color as described above.

For each listed race, an exemplary return on investment board shown in FIG. 15 displays the track name (or abbreviation) in column 2036, the date the wager was placed or the date that the race was run in column 2034, the race number in column 2038, the race class in column 2040, the race distance in column 2042 (in meters, yards or furlongs), the surface type in column 2044 (e.g., “D” for Dirt or “T” for “Turf”), as well as the pertinent user wager data described hereafter. The race number 2038 is preferably “clickable” by the user, such that if the user clicks or otherwise selects the race number, the race results for the race are preferably displayed to the user by the user terminal, for example in the form shown in FIG. 8A and generated by track board module 2000.

User wager data is shown in the exemplary return on investment board in columns 2046, 2048, 2050, 2052, and 2054. The “Bet Type” for each wager is listed in column 2046. Referring to the #3 race at “LRL” park as an example, the user placed a “$15-WP” wager—a fifteen dollar win/place wager. The entry or entries selected by the user for the wager are listed in column 2048. In this case, the user placed a fifteen dollar win/place wager on the number “4” horse. The actual number of bets placed by the user in the wager is shown in column 2050. A win/place wager on one horse is actually “2” bets, as shown in column 2050. If the user “clicks” within column 2046 for a specific race, each of the individual bets placed by the user by that wager are preferably displayed. This is particularly helpful to a user for more complicated wagers, such as exactas and trifectas with several combinations of horses. The total amount of the wager is costed and shown in column 2052. A fifteen dollar win/place wager on a single horse is costed by the return on investment board module 2000 (in a manner described above in connection with the IVR code module 500) at thirty dollars, as shown by the “30” in column 2052. The total net profit or loss for the wager is listed in column 2054. Column 2054 for the #3 race at LRL shows “Pending,” indicating that the race is either not complete or that results and payouts for the race are not yet available or final. Conversely, column 2054 for the #6 race at track “PHA” indicates that the wager netted a profit of $56 dollars—an $86 dollar return on the $30 total wager amount shown in column 2052.

As shown by checkboxes 2056, the user can also customize the racing data shown for the list of races. Additional racing data, such as track conditions (“Condition”), age restrictions (“Age”), sex restriction (“Sex”), number of runners (“Field_Size”), claim minimum (“ClmMin”), and claim maximum (“ClmMax”), can be added or deleted as columns in the list of races by selecting (or deselecting) the appropriate checkbox and by selecting the “submit” button 2060. The displayed list may also be reorganized. As mentioned, the list as shown is initially organized by “Date.” The user may select any of the labels in row 2062 to reorganize the list. For example, if the user selects “Amount” from row 2062 by “clicking” on “Amount,” the list is then organized in either ascending or descending order of the total amount or cost of the wagers. Selecting “Amount” again reverses the listing order.

The races, and therefore the wagers on those race, contained within or associated with a particular wagering portfolio may also be searched in order to identify the wagers that share common racing data and/or user wager data. The portfolio is preferably searchable according to any stored racing data or user wager data as search parameters. An exemplary return on investment module 2000 and return on investment board provides the user the option of searching the listed races for races of either “ALL” classes or selected classes as shown by pull down window 2064 and FIG. 15A. Pull down window (shown opened in FIG. 15B) also allows the user to search the listed races by wager or bet type, by bet amount, by track code or name, by race age limitation, by race distance in furlongs, miles or yards, by track surface, by field size or by no restriction at all. Pull down window 2068 (shown opened in FIG. 15C) functions like window 1020b of FIG. 10B. For example, the user can select in window 2066 “Bet Amount” and then select from window 2068 “is Less Than <”. The user then enters a dollar amount (such as “15”) in “Enter Code” window 2070. Once the user selects the “Submit” button 2060, the race listing is narrowed to list only the races wagered upon by the user in the selected portfolio that meet the selected search criteria, i.e., wagers placed by the user on races that amounted to less that $15 (as shown in column 2052). Also, although not shown in the Return on Investment board of FIG. 15, the user is preferably provided the option of limiting a search to a particular time frame. For example, a user may wish to limit a search to wagers that were placed between September 1^{st} and October 1^{st} of a specific year.

A Return on Investment module may also provide a user with the option of searching for placed wagers using a natural language search method. These methods are utilized for researching in some legal databases and allow a user to enter a query as a question or a command. In this embodiment, natural language searching software identifies certain key words from the question or command (e.g., “exacta,” Philadelphia Park,” etc.) and structures an appropriate query for searching the wagering and racing data for corresponding wagers placed by the user.

Row 2072 displays wagering return data corresponding to a summary of returns for the wagers placed by the user that satisfy the search parameters selected by the user and entered via windows 2030, 2064, 2066, 2068, and 2070. Of course, the wagering return data corresponding to returns for an individual portfolio may be displayed by selecting the portfolio from window 2030. Still further, the returns for the user's entire wagering history may be calculated and displayed by selecting the appropriate portfolio from window 2030 and by selecting the broadest possible options from windows 2064, 2066, 2068 and 2070, e.g., by selecting all classes of races from window 2064 and no further limitations from windows 2066, 2068 and 2070.

Starting from the left, the summary row lists several different calculated returns for the wagers placed by the user that satisfy the search parameters selected. A normalized return on a selected wager amount for the wagers is first shown as “Roi: 1.65.” For purposes of this example, 1.65 indicates that the user has realized $1.65 on every $2.00 wagered through the wagers identified in response to a search query (or default listing), i.e., those wagers listed in the displayed list of the return on investment board and those wagers available by selecting selectable numbers 2032. An “Roi” over $2.00 indicates a profit whereas an “Roi” less than $2.00 indicates a loss. In the above example, the user loses 35 cents for each $2.00 he wagers. The total number of bets, not the number of races wagered upon, is also preferably shown in row 2072 next to “# of Bets:”. The sum of column 2050 for all races returned by the search query (not just those necessarily shown on an individual screen) is displayed adjacent “# of Bets:”. The “# of Winning Bets” listed on row 2072 indicates those bets out of the total “# of Bets” that returned a profit. A winning percentage, i.e., the number of wining bets divided by the number of total bets multiplied by one hundred percent, although not shown on row 2072, may also be calculated from these numbers and be displayed. The total net profit or loss for all of the wagers placed by the user that satisfy the search parameters is also preferably displayed next to “Profit/Loss:” on line 2072. This feature provides the user a quantitative net value of the results of his or her wagering. Finally, the percentage return on the user's investment is shown next to indicator “%on$:”. This number indicates the percentage return that the user has realized. If the user has only realized $1.65 on every $2.00 bet, the user realizes a 17.5% loss or a negative gain of 17.5%. This value may be rounded in any selected manner.

The returns shown on summary row 2072 are recalculated when the user selects new search parameters and are displayed along with a new race listing on the return on investment board. This re-calculation is preferably accomplished in real-time by the return on investment module 2000 each time the user selects a new search. This feature accounts for any new bets which may have recently been placed by the user or any results on previously pending bets which have recently become final and available.

In this manner, the return on investment module 2000 not only provides the user with exemplary access to user wager data and racing data associated with the races upon which the user has placed wagers, but also allows the user to examine wagering techniques which have proved profitable for, or harmful to, the user. Further, the user can place mock wagers through virtual bet module 700 and examine the results using return on investment module 2000 in order to “fine tune” or evaluate different wagering or handicapping strategies.

A return on investment module 2000 may be used to track wagers and analyze returns, as well as hone wagering strategies, in relation to a plurality of different contest events, such as horse racing contests, dog racing contests, automobile racing contests, basketball contests, football contests, soccer contests, hockey contests, baseball contests, golf contests, tennis contests, jaialai contests, game show contests, or casino games. For example, the user may maintain a football portfolio, with college and professional sub-portfolios. The user can then use the return on investment module 2000 to analyze his returns on Monday night football games, on bowl games, on specific teams, on football generally, or on over-under wagers, to name a few exemplary uses of the system and method of the present invention.

It should be understood that although the term “wager” and “bet” have been used herein primarily in terms of risking money on an uncertain event, this is not a requirement. It is envisioned that some contests and systems may allow wagering of non-monetary currencies, such as frequent flyer miles, tickets which may be exchanged for prizes or services, points which signify wagering prowess or which may be exchanged for goods and services, to name a few.

The exemplary modules described above may be utilized in connection with an IVR code wagering system or a system which allows for direct wagering through a computer network, such as the Internet, to form a comprehensive wagering system. Of course, a user may also use the modules to obtain any desired information and then place a wager in another manner, such as through an OTB or in person at a race-track. In one exemplary system, the user calls a telephone wagering system to place a wager where the telephone wagering system utilizes voice recognition software. This wagering system first verifies that the user has an account with the wagering system and then receives a selected wager from the user orally. For example, the user could state, “I would like to place a five dollar bet on horse number five in the fifth race at Philadelphia Park on May fifth.” The software identifies key words, such as Philadelphia Park, and constructs a wager from the oral statement. The system preferably verifies the wager with the user before executing the wager, such as by reading back the constructed wager to the user over the telephone for affirmative verification from the user. Such a system removes some of the rigidity inherent in IVR code systems because the wager need not be placed in any specific manner or order in order to be recognized.

The present invention can be embodied in the form of methods and apparatus for practicing those methods. The present invention can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

Although the invention has been described in terms of exemplary embodiments, it is not limited thereto. Rather, the appended claims should be construed broadly to include other variants and embodiments of the invention that may be made by those skilled in the art without departing from the scope and range of equivalents of the invention.

What is claimed is:

1. A method of providing wagering return data to a user through a computer network, comprising the steps of:
prompting through said computer network said user to select using a user terminal at least one search parameter for a search of contest data for a plurality of contest events and user wager data, said user wager data identifying a plurality of wagers, said plurality of wagers being placed by said user on contest events from said plurality of contest events, in order to identify wagers placed by said user that satisfy said at least one search parameter;
receiving at least one search parameter selected by said user;
identifying wagers placed by said user that satisfy said at least one search parameter selected by said user;
calculating a return on said wagers placed by said user that satisfy said at least one search parameter selected by said user; and
displaying said wagering return data corresponding to said return to said user with said user terminal.

2. The method of claim 1, wherein said wagering return data identify a number of winning bets from said wagers placed by said user that satisfy said at least one search parameter selected by said user, a total net profit on said wagers placed by said user that satisfy said at least one search parameter selected by said user, a percentage return on said wagers placed by said user that satisfy said at least one search parameter selected by said user, a normalized return on a selected wager amount for said wagers placed by said user that satisfy said at least one search parameter selected by said user, a percentage of all bets that are winning bets from said said wagers placed by said user that satisfy said at least one search parameter selected by said user, or a combination thereof.

3. The method of claim 2, wherein said user wager data include bet type for each wager, bet amount for each wager, net profit for each wager, date when each wager was placed, or a combination thereof.

4. The method of claim 3, further comprising the step of displaying with said user terminal to said user a listing of contest events corresponding to said wagers placed by said user that satisfy said at least one search parameter selected by said user.

5. The method of claim 4, further comprising the step of displaying user wager data and contest data for each of said contest events in said listing of contest events.

6. The method of claim 5, further comprising the step of causing said listing to be organizable by contest data and user wager data selected by said user with said user terminal, wherein said listing organized by contest data and user wager data selected by said user is displayed to said user with said user terminal.

7. The method of claim 1, wherein said contest events are horse racing contests, dog racing contests, automobile racing contests, basketball contests, football contests, soccer contests, hockey contests, baseball contests, golf contests, tennis contests, jaialai contests, game show contests, or casino game contests.

8. The method of claim 1, further comprising the steps of:
transmitting a list of contest events from said plurality of contest events that have not yet been completed through said computer network to said user terminal, wherein said list of contest events is displayed to said user with said user terminal;
prompting said user to place a wager on at least one of said listed contest events;
comparing a wager selected by said user with results of said listed contest events; and
storing user wager data for said wager selected by said user.

9. The method of claim 8, wherein said wager selected by said user is a mock wager.

10. A system for providing wagering return data to a user through a computer network, comprising:
contest database including contest data for a plurality of contest events;
a user wager data database including user wager data identifying a plurality of wagers, said plurality of wagers being placed by said user on contest events from said plurality of contest events;
a server connected to said computer network comprising:
means for prompting said user through said computer network to select using a user terminal at least one search parameter for a search of said user wager data and said contest data in order to identify wagers placed by said user that satisfy said at least one search parameter;
means for receiving at least one search parameter selected by said user;
means for identifying wagers placed by said user that satisfy said at least one search parameter selected by said user;
means for calculating a return on said wagers placed by said user that satisfy said at least one search parameter selected by said user; and
means for displaying wagering return data corresponding to said return to said user with said user terminal.

11. The system of claim 10, wherein said wagering return data identify a number of winning bets from said wagers placed by said user that satisfy said at least one search parameter selected by said user, a total net profit on said wagers placed by said user that satisfy said at least one search parameter selected by said user, a percentage return on said wagers placed by said user that satisfy said at least one search parameter selected by said user, a normalized return on a selected wager amount for said wagers placed by said user that satisfy said at least one search parameter selected by said user, a percentage of all bets that are winning bets from said said wagers placed by said user that satisfy said at least one search parameter selected by said user, or a combination thereof.

12. The system of claim 11, wherein said user wager data include bet type for each wager, bet amount for each wager, net profit for each wager, date when each wager was placed, or a combination thereof.

13. The system of claim 12, wherein said server further comprises means for causing said user terminal to display to said user a listing of contest events corresponding to said wagers placed by said user that satisfy said at least one search parameter selected by said user.

14. The system of claim 13, wherein said server further comprises means for causing said user terminal to display to said user user wager data and contest data for each of said contest events in said listing of contest events.

15. The system of claim 14, wherein said server further comprises means for causing said listing to be organizable by contest data and user wager data selected by said user, where in said listing organized by contest data and user wager data selected by said user is displayed to said user with said user terminal.

16. The system of claim 10, wherein said contest events are horse racing contests, dog racing contests, automobile racing contests, basketball contests, football contests, soccer contests, hockey contests, baseball contests, golf contests, tennis contests, jaialai contests, game show contests, or casino game contests.

17. The system of claim 10, further comprising said user terminal and said computer network, said user terminal connected to said server through said computer network.

18. The system of claim 10, wherein said server further comprises:
means for transmitting a list of contest events from said plurality of contest events that have not yet been completed through said computer network to said user terminal, wherein said list of contest events is displayed to said user with said user terminal;
means for prompting said user to place a wager on at least one of said listed contest events;
means for comparing a wager selected by said user with results of said listed contest events; and
means for storing user wager data for said wager selected by said user.

19. A method of providing wagering return data to a user through a computer network, comprising the steps of:
receiving at least one search parameter for a search of racing data for a plurality of racing events and user wager data, said user wager data identifying a plurality of wagers, said plurality of wagers being placed by said user on racing events from said plurality of racing events, in order to identify wagers placed by said user that satisfy said at least one search parameter;
identifying wagers placed by said user that satisfy said at least one search parameter selected by said user;
calculating a return on said wagers placed by said user that satisfy said at least one search parameter selected by said user; and
displaying wagering return data corresponding to said return to said user using a user terminal.

20. The method of claim 19, wherein said wagering return data identify a number of winning bets from said wagers placed by said user that satisfy said at least one search parameter selected by said user, a total net profit on said wagers placed by said user that satisfy said at least one search parameter selected by said user, a percentage return on said wagers placed by said user that satisfy said at least one search parameter selected by said user, a normalized return on a selected wager amount for said wagers placed by said user that satisfy said at least one search parameter selected by said user, a percentage of all bets that are winning bets from said said wagers placed by said user that satisfy said at least one search parameter selected by said user, or a combination thereof.

21. The method of claim 20, wherein said user wager data include a bet type for each wager, a bet amount for each wager, a net profit for each wager, a number of bets placed within each wager, race entries selected for each wager, a date when each wager was placed, or a combination thereof.

22. The method of claim 19, wherein said racing data include race entry data and race characteristic data for each racing event.

23. The method of claim 22, wherein said race entry data include an identity of each horse entered in each racing event, a respective jockey, trainer, or owner of each horse entered in each racing event, or a combination thereof, and said race characteristic data include for each racing event a race class, race sub-class, track name, track code, race age limitation, race distance, surface type, number of runners, purse amount, claim amount, equipment identifier, medication identifier, breed limitation, horse sex limitation, claim minimum, claim maximum, status of race, weather conditions, or a combination thereof.

24. The method of claim 23, further comprising the step of displaying with said user terminal to said user a listing of races corresponding to said wagers placed by said user that satisfy said at least one search parameter selected by said user.

25. The method of claim 24, further comprising the step of displaying racing data and user wager data for each of said races in said listing of races.

26. The method of claim 25, further comprising the step of causing said listing to be organizable by racing data and user wager data selected by said user with said user terminal, wherein said listing organized by racing data and user wager data selected by said user is displayed to said user with said user terminal.

27. The method of claim 19, wherein said user wager data include bet type for each wager, bet amount for each wager, net profit for each wager, number of bets placed within each wager, race entries selected for each wager, date when a wager was placed, or a combination thereof, and said racing data include race entry data and race characteristic data for each racing event, said race entry data including an identity of each horse entered in each racing event, a respective jockey, trainer, or owner of each horse entered in each racing event, or a combination thereof, and said race characteristic data including a race number, race class, race sub-class, track name, track code, race age limitation, race distance, surface type, number of runners, purse amount, claim amount, equipment identifier, medication identifier, breed limitation, horse sex limitation, claim minimum, claim maximum, status of race, weather conditions, or a combination thereof for each racing event.

28. The method of claim 27, further comprising the step of displaying with said user terminal to said user a listing of races corresponding to said wagers placed by said user that satisfy said at least one search parameter selected by said user.

29. The method of claim 28, further comprising the step of displaying racing data and user wager data for each of said races in said listing of races.

30. The method of claim 29, further comprising the step of causing said listing to be organizable by racing data and user wager data selected by said user with said user terminal, wherein said listing organized by racing data and user wager data selected by said user is displayed to said user with said user terminal.

31. The method of claim 19, further comprising the step of prompting said user to select a wagering portfolio from which to search said user wager data.

32. The method of claim 31, wherein said wagering portfolio is a portfolio identifying wagers placed by said user through an interactive voice response system, mock wagers placed by said user, wagers placed with a totalizator through an Internet wagering system, wagers placed by said user at off-track wagering locations, wagers placed by said user live at tracks, or a combination thereof.

33. The method of claim 19, further comprising the steps of:
transmitting a list of races from said plurality of races that have not yet been run through said computer network to said user terminal, wherein said list of races is displayed to said user with said user terminal;
prompting said user to place a wager on at least one of said listed races;
comparing a wager selected by said user with results of said listed races; and
storing user wager data for said selected wager.

34. The method of claim 33, wherein said wager selected by said user is a mock wager.

35. A system for providing wagering return data to a user through a computer network, comprising:
a racing database comprising racing data for a plurality of racing events;
a wager database comprising wager data identifying a plurality of wagers, said plurality of wagers being placed by said user on racing events from said plurality of racing events; and
a server connected to said computer network comprising:
means for prompting through said computer network said user to select using a user terminal at least one search parameter for a search of said user wager data and said racing data in order to identify wagers placed by said user that satisfy said at least one search parameter;
means for receiving at least one search parameter selected by said user;
means for identifying wagers placed by said user that satisfy said at least one search parameter selected by said user;
means for calculating a return on said wagers placed by said user that satisfy said at least one search parameter selected by said user; and
means for causing wagering return data corresponding to said return to be displayed to said user with said user terminal.

36. The system of claim 35, wherein said wagering return data identify a number of winning bets from said wagers placed by said user that satisfy said at least one search parameter selected by said user, a total net profit on said wagers placed by said user that satisfy said at least one search parameter selected by said user, a percentage return on said wagers placed by said user that satisfy said at least one search parameter selected by said user, a normalized return on a selected wager amount for said wagers placed by said user that satisfy said at least one search parameter selected by said user, a percentage of all bets that are winning bets from said said wagers placed by said user that satisfy said at least one search parameter selected by said user, or a combination thereof.

37. The system of claim 36, wherein said user wager data include bet type for each wager, bet amount for each wager, a net profit each wager, number of bets placed within each wager, race entries selected for each wager, date when each wager was placed, or a combination thereof, and said racing data include race entry data and race characteristic data for each racing event, said race entry data including an identity of each horse entered in each racing event, a respective jockey, trainer, or owner of each horse entered in each racing event, or a combination thereof, and said race characteristic data including a race number, race class, race sub-class, track name, track code, race age limitation, race distance, surface type, number of runners, purse amount, claim amount, equipment identifier, medication identifier, breed limitation, horse sex limitation, claim minimum, claim maximum, status of race, weather conditions, or a combination thereof for each racing event.

38. The system of claim 37, wherein said server further comprises means for causing a listing of races corresponding to said wagers placed by said user that satisfy said at least one search parameter selected by said user to be displayed to said user with said user terminal.

39. The system of claim 38, wherein said server further comprises means for causing racing data and user wager data for each of said races in said listing of races to be displayed to said user with said user terminal.

40. The system of claim 39, wherein said server further comprises means for causing said listing to be organizable by racing data and user wager data selected by said user, wherein said listing organized by racing data and user wager data selected by said user is displayed to said user by said user terminal.

41. The system of claim 35, wherein said server further comprises means for prompting said user through said computer network to select a wagering portfolio from which to search said user wager data and wherein said wagering portfolio is a portfolio identifying wagers placed by said user through an interactive voice response system, mock wagers placed by said user, wagers placed by said user with a totalizator through an Internet wagering system, wagers placed by said user at off-track wagering locations, wagers placed by said user live at tracks, or a combination thereof.

42. The system of claim 35, further comprising said user terminal and said computer network, said user terminal connected to said server through said computer network.

43. The system of claim 35, wherein said server further comprises:
means for transmitting a list of races from said plurality of racing events that have not yet been run through said computer network to said user terminal, wherein said list of races is displayed to said user with said user terminal;
means for prompting said user to place a wager on at least one of said listed races;
means for comparing a wager selected by said user with results of said listed races; and
means for storing user wager data for said wager selected by said user.
